(19) United States
(12) Patent Application Publication
(10) Pub. No.: US 2025/0358893 A1
(43) Pub. Date: Nov. 20, 2025

(54) ADJUSTMENT INDICATIONS AND ASSOCIATED ACKNOWLEDGEMENTS FOR EXTENDED REALITY (XR) COMMUNICATIONS

(71) Applicant: QUALCOMM Incorporated, San Diego, CA (US)

(72) Inventors: Fang YUAN, Beijing (CN); Iyab Issam SAKHNINI, San Diego, CA (US); Tao LUO, San Diego, CA (US)

(21) Appl. No.: 18/870,895

(22) PCT Filed: Aug. 2, 2022
(86) PCT No.: PCT/CN2022/109636

§ 371 Date: Dec. 2, 2024

(51) Int. Cl. H04W 76/28; H04L 5/00; H04W 72/23

(52) U.S. Cl. CPC H04W 76/28; H04L 5/0055; H04W 72/23

(57) ABSTRACT

Wireless communication devices, systems, and methods related to adjusting aspects of a connected discontinuous reception (CDRX) operation and/or a semi-persistent scheduling (SPS) operation for extended reality (XR) communications are provided. For example, a method of wireless communication performed by a user equipment can include receiving an adjustment indication indicating at least one of a starting time or a length of a connected discontinuous reception (CDRX) on-duration; transmitting an acknowledgment (ACK) associated with the adjustment indication; and monitoring, based on the at least one of the starting time or the length of the CDRX on-duration, for a communication.

### TECHNICAL FIELD

This application relates to wireless communication systems, and more particularly to methods (and associated devices and systems) for adjusting aspects of a connected discontinuous reception (CDRX) operation and/or a semi-persistent scheduling (SPS) operation for extended reality (XR) communications and other wireless communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Extended reality (XR) continues to be a growing area of wireless communication usage. XR can include augmented reality (AR), mixed reality (MR) and/or virtual reality (VR) devices, systems, and/or communications. An XR device can be a mobile device (e.g., phone, tablet, glasses, watch, goggles, etc.) that facilitates XR wireless communications, including supporting wireless data exchanges with a server. Many XR applications support dynamic reconstruction of a three-dimensional (3D) environment and/or fusion of a real-world environment with a virtual environment. As a result, XR applications can require high quality video and/or audio data communications with low latency and/or variability in the number and/or size of data packets, which can cause significant power demands on the XR devices. At the same time, because many XR devices are wearable and mobile, users have an expectation for the XR devices to provide good battery life and remain comfortable during use (e.g., avoiding overheating), providing an overall good user experience. As a result, there is a need to provide efficient designs for wireless data communications, including XR data communications, in a manner that delivers users with the expected levels of communication latency and throughput, while also providing power savings and prolonged battery life.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment includes receiving an adjustment indication indicating at least one of a starting time or a length of a connected discontinuous reception (CDRX) on-duration; transmitting an acknowledgment (ACK) associated with the adjustment indication; and monitoring, based on the at least one of the starting time or the length of the CDRX on-duration, for a communication. Associated devices, systems, means, and/or non-transitory computer readable media having one or more instructions for execution by one or more processors of a user equipment are also provided.

In an additional aspect of the disclosure, a method of wireless communication performed by a network unit includes transmitting an adjustment indication indicating at least one of a starting time or a length of a connected discontinuous reception (CDRX) on-duration; receiving an acknowledgment (ACK) associated with the adjustment indication; and transmitting, based on the at least one of the starting time or the length of the CDRX on-duration, a communication. Associated devices, systems, means, and/or non-transitory computer readable media having one or more instructions for execution by one or more processors of a network unit are also provided.

In an additional aspect of the disclosure, a method of wireless communication performed by a user equipment includes monitoring for a wake-up signal (WUS) during one or more monitoring occasions associated with a connected discontinuous reception (CDRX) on-duration; and monitoring, based on failing to receive the WUS during the one or more monitoring occasions, for a communication associated with a data flow during the CDRX on-duration, wherein a starting time of the CDRX on-duration is based on a nominal starting time of the CDRX on-duration and a maximum jitter of the data flow. Associated devices, systems, means, and/or non-transitory computer readable media having one or more instructions for execution by one or more processors of a user equipment are also provided.

In an additional aspect of the disclosure, a method of wireless communication performed by a user equipment includes receiving an adjustment indication indicating at least one of a starting time or a length of a semi-persistent scheduling (SPS) occasion; transmitting an acknowledgment (ACK) associated with the adjustment indication; and monitoring, based on the at least one of the starting time or the length of the SPS occasion, for a communication. Associated devices, systems, means, and/or non-transitory computer readable media having one or more instructions for execution by one or more processors of a user equipment are also provided.

In an additional aspect of the disclosure, a method of wireless communication performed by a network unit includes transmitting an adjustment indication indicating at least one of a starting time or a length of a semi-persistent scheduling (SPS) occasion; receiving an acknowledgment (ACK) associated with the adjustment indication; and transmitting, based on the at least one of the starting time or the length of the SPS occasion, a communication. Associated devices, systems, means, and/or non-transitory computer readable media having one or more instructions for execution by one or more processors of a network unit are also provided.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates examples of extended reality (XR) devices according to some aspects of the present disclosure.

FIG. 4 illustrates a wireless communication scheme according to some aspects of the present disclosure.

FIG. 5 illustrates a wireless communication scheme according to one or more aspects of the present disclosure.

FIG. 6 illustrates a wireless communication scheme according to one or more aspects of the present disclosure.

FIG. 7 illustrates a wireless communication scheme according to one or more aspects of the present disclosure.

FIG. 8 illustrates a wireless communication scheme according to one or more aspects of the present disclosure.

FIG. 9 illustrates a wireless communication scheme according to one or more aspects of the present disclosure.

FIG. 10 is a block diagram of a user equipment (UE) according to one or more aspects of the present disclosure.

FIG. 11 is a block diagram of a network unit according to one or more aspects of the present disclosure.

FIG. 12 illustrates a flow diagram of a wireless communication method according to some aspects of the present disclosure.

FIG. 13 illustrates a flow diagram of a wireless communication method according to some aspects of the present disclosure.

FIG. 14 illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3 GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, and/or as instructions stored on a computer readable medium for execution on a processor or computer. Furthermore, an aspect may comprise at least one element of a claim.

Aspects of the present disclosure allow a UE and/or a network unit to address the variability in the timing of XR traffic to improve network efficiency, network throughput, user experiences, power consumption, processing requirements, etc. In some aspects, a starting time and/or a length of a periodic communication period (e.g., CDRX on-duration, SPS occasion, etc.) may be adjusted to better align with the data flow(s) associated with XR or other communications. In some aspects, a UE receives an adjustment indication indicating at least one of a starting time or a length of a connected discontinuous reception (CDRX) on-duration; transmits an acknowledgment (ACK) associated with the adjustment indication; and monitors, based on the at least one of the starting time or the length of the CDRX on-duration, for a communication. In an additional aspect of the disclosure, the UE monitors for an adjustment indication and/or a wake-up signal (WUS) during one or more monitoring occasions associated with a CDRX on-duration and, based on failing to receive the WUS during the one or more monitoring occasions, monitors for a communication associated with a data flow during the CDRX on-duration, wherein a starting time of the CDRX on-duration is based on a nominal starting time of the CDRX on-duration and a maximum jitter of the data flow. In another aspect of the present disclosure, a UE receives an adjustment indication indicating at least one of a starting time or a length of a semi-persistent scheduling (SPS) occasion; transmits an acknowledgment (ACK) associated with the adjustment indication; and monitors, based on the at least one of the starting time or the length of the SPS occasion, for a communication.

Aspects of the present disclosure provide several advantages over existing methods and systems, including facilitating adjustment of starting times and/or lengths of CDRX on-durations and/or SPS occasions (and providing associated acknowledgements of such adjustments) that can improve network efficiency and/or throughput, while also reducing power consumption, reducing processing requirements, and providing an improved user experience, among other benefits. The benefits are particular in the context of variable data flows, including XR data flows, but are applicable to other types of communications as well.

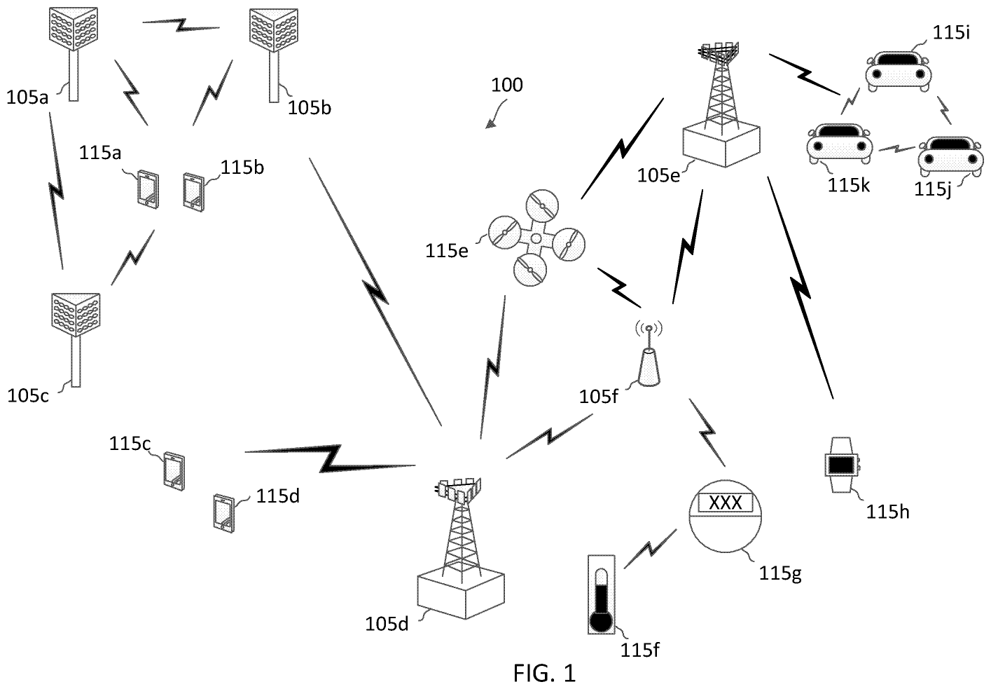

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL and/or UL, desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal can have a particular pilot pattern or structure, where pilot tones may span across an operational BW or frequency band, each positioned at a pre-defined time and a pre-defined frequency. For instance, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response can be referred to as message 1 (MSG1), message 2 (MSG2), message 3 (MSG3), and message 4 (MSG4), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For instance, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For instance, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

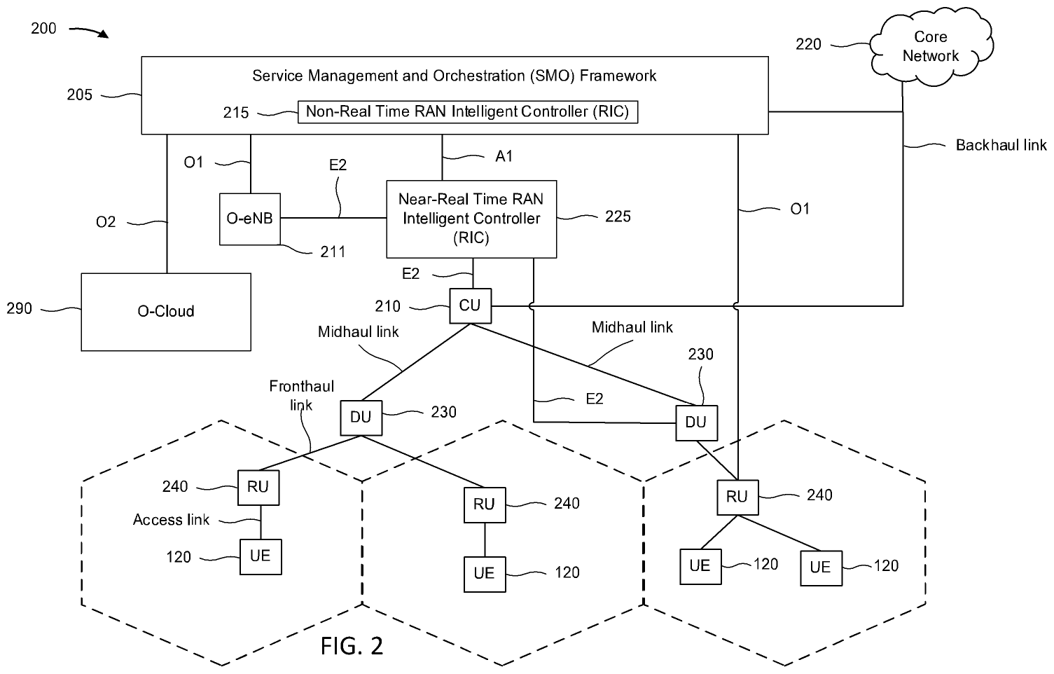

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 120 via one or more radio frequency (RF) access links. In some implementations, the UE 120 may be simultaneously served by multiple RUs 240.

Each of the units, i.e., the CUS 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 120. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

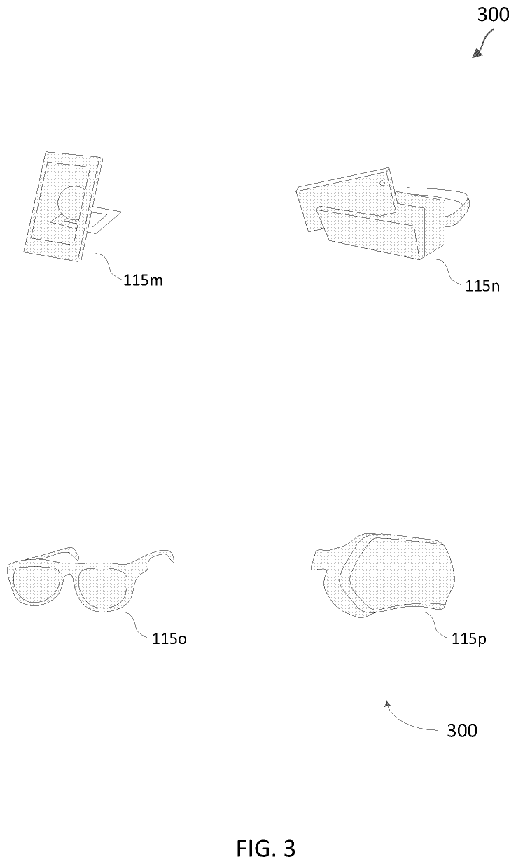

FIG. 3 illustrates examples of extended reality (XR) devices according to some aspects of the present disclosure. In particular, the XR devices 300 illustrated in FIG. 3 include (1) an AR and/or MR smartphone, tablet, or portable console 115m; (2) an AR, MR, and/or VR wearable system that includes a smartphone, tablet, or portable console along with a mounting structure (e.g., head band configured to received and/or couple with the smartphone, tablet, or portable console) 115n; (3) AR and/or MR smart glasses 1150; and (4) VR goggles 115p. In some instances, the XR devices 300 are UEs (e.g., UE 115 and/or UE 1000). It is understood that aspects of the present disclosure are generally suitable for use with any type of XR devices, not only those shown in FIG. 3. Further, it is understood that each of the XR devices 300 may be tethered to other devices, including smartphones, personal computers (PCs), or consoles. Accordingly, an XR device may connect to another device using a universal serial bus (USB) link, a Bluetooth link, a Wi-Fi link, a 5G sidelink, or other suitable connection. In some instances, an XR device receives downlink data from a server, host, or other device through the device that the XR device is tethered to. Accordingly, it is understood that aspects of the present disclosure are suitable for use with XR devices alone and/or tethered to one or more other devices through which the XR device receives data.

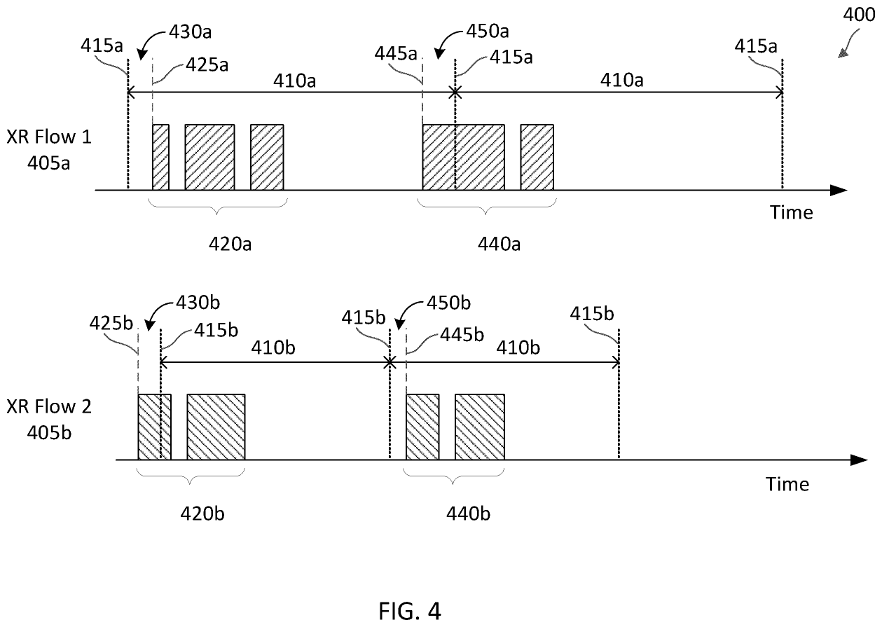

FIG. 4 illustrates a wireless communication scheme 400 according to some aspects of the present disclosure. The wireless communication scheme 400 includes multiple XR data flows, including an XR Flow 1 405a and an XR flow 2 405b. While FIG. 4 shows two XR data flows, the present disclosure is applicable to non-XR data communications as well as single XR data flows and more than two XR data flows.

XR data flows may have variability in the number and/or size of the packets per data burst. Further, XR data flows may be based on non-integer time periods (e.g., 60 frames per second is equivalent to a ˜16.67 ms period; 120 frames per second is equivalent to an ˜8.33 ms period). Further still, the arrival time of XR traffic may vary (e.g., jitter between −4 ms and +4 ms, or other values, may be observed). Also, when multiple XR data flows are active, one or more of the XR data flows may have a different configuration than another of the XR data flows. XR data flows may also be subject to a packet delay budget than can affecting scheduling and/or latency of the communications. The XR Flow 1 405a and the XR flow 2 405b illustrate some of these aspects of XR data flows.

As shown, XR Flow 1 405a may be associated with a periodic communication scheme (e.g., CDRX, SPS, etc.) having a period 410a. The period 410a may be an integer time period (e.g., 5, 10ms, 20 ms, etc.) or a non-integer time period (e.g., ˜8.33 ms, ˜16.67 ms, etc.). Based on the period 410a, XR Flow 1 405a may have nominal starting times 415a. The nominal starting times 415a are separated in time by the period 410a.

XR Flow 1 405a may include a first data burst 420a comprised of one or multiple data packets and/or transport blocks. In the illustrated example, the first data burst 420a includes three packets and/or transport blocks of varying size, but it is understood that the first data burst 420a may include any number of packets and/or transport blocks of the same or differing sizes. A starting time 425a of the first data burst 420a may be offset from the nominal starting time 415a by an offset 430a. In some instances, the offset 430a may be a result of jitter and/or other factors affecting the transmission and/or arrival time of the first data burst 420a. In the illustrated example, the starting time 425a of the first data burst 420a is delayed (i.e., later in time) relative to the nominal starting time 415a.

XR Flow 1 405a may include a second data burst 440a comprised of one or multiple data packets and/or transport blocks. In the illustrated example, the second data burst 440a includes two packets and/or transport blocks of varying size, but it is understood that the second data burst 440a may include any number of packets and/or transport blocks of the same or differing sizes. A starting time 445a of the second data burst 440a may be offset from the nominal starting time 415a by an offset 450a. In some instances, the offset 450a may be a result of jitter and/or other factors affecting the transmission and/or arrival time of the second data burst 440a. In the illustrated example, the starting time 445a of the second data burst 440a is early (i.e., before in time) relative to the nominal starting time 415a.

As also shown, XR Flow 2 405b may be associated with a periodic communication scheme (e.g., CDRX, SPS, etc.) having a period 410b. The period 410b may be the same or different than the period 410a of XR Flow 1 405a. In the illustrated example, the period 410b is shorter than the period 410a. The period 410b may be an integer time period (e.g., 5, 10 ms, 20 ms, etc.) or a non-integer time period (e.g., ˜8.33 ms, ˜16.67 ms, etc.). Based on the period 410b, XR Flow 2 405b may have nominal starting times 415b. The nominal starting times 415b are separated in time by the period 410b.

XR Flow 2 405b may include a first data burst 420b comprised of one or multiple data packets and/or transport blocks. In the illustrated example, the first data burst 420b includes two packets and/or transport blocks of varying size, but it is understood that the first data burst 420b may include any number of packets and/or transport blocks of the same or differing sizes. A starting time 425b of the first data burst 420b may be offset from the nominal starting time 415b by an offset 430b. In some instances, the offset 430b may be a result of jitter and/or other factors affecting the transmission and/or arrival time of the first data burst 420b. In the illustrated example, the starting time 425b of the first data burst 420b is early (i.e., before in time) relative to the nominal starting time 415b.

XR Flow 2 405b may include a second data burst 440b comprised of one or multiple data packets and/or transport blocks. In the illustrated example, the second data burst 440b includes two packets and/or transport blocks of varying size, but it is understood that the second data burst 440b may include any number of packets and/or transport blocks of the same or differing sizes. A starting time 445b of the second data burst 440b may be offset from the nominal starting time 415b by an offset 450b. In some instances, the offset 450b may be a result of jitter and/or other factors affecting the transmission and/or arrival time of the second data burst 440b. In the illustrated example, the starting time 445b of the second data burst 440a is delayed (i.e., later in time) relative to the nominal starting time 415a.

Aspects of the present disclosure allow a UE and/or a network unit to address the variability in the timing of XR traffic. In some aspects, a starting time and/or a length of a periodic communication period (e.g., CDRX on-duration, SPS occasion, etc.) may be adjusted to better align with the data flow(s) associated with XR or other communications.

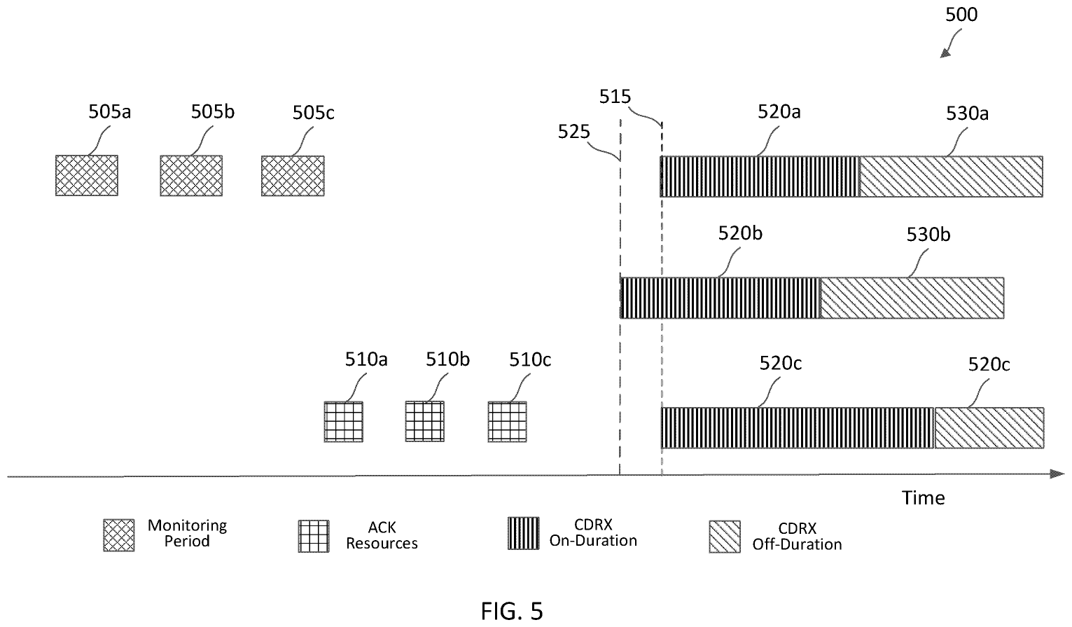

FIG. 5 illustrates a wireless communication scheme 500 according to one or more aspects of the present disclosure. The wireless communication scheme 500 includes monitoring occasions 505a, 505b, and 505c, acknowledgement (ACK) resources 510a, 510b, and 510c, a nominal starting time 515, CDRX on-durations 520a, 520b, and 520c, an adjusted starting time 525, and CDRX off-durations 530a, 530b, and 530c. In this regard, the ACK resources 510a, 510b, and 510c may be respectively associated with the monitoring occasions 505a, 505b, and 505c (e.g., ACK resource 510a may be associated with monitoring occasion 505a, ACK resource 510b may be associated with monitoring occasion 505b, ACK resource 510c may be associated with monitoring occasion 505c, etc.). While FIG. 5 illustrates three monitoring occasions 505a, 505b, and 505c, it is understood that any suitable number of monitoring occasions may be utilized, including fewer (e.g., 1 or 2) or more (4, 5, 6, etc.).

A UE (e.g., UE 115 or UE 1000) may receive from a network unit a configuration or other communication indicating a location (e.g., time and/or frequency resources) of the one or more monitoring occasions 505a, 505b, and 505c. The monitoring occasions 505a, 505b, and 505c may occupy physical downlink control channel (PDCCH) resources and/or a physical downlink shared channel (PDSCH) resources. The UE may monitor the monitoring occasions 505a, 505b, and 505c for an adjustment indication that indicates at least one of a starting time of a connected discontinuous reception (CDRX) on-duration (e.g., CDRX on-durations 520a, 520b, and 520c) and/or a length of a CDRX on-duration (e.g., CDRX on-durations 520a, 520b, and 520c). In some aspects, the adjustment indication may additionally indicate to the UE whether to wake up for the next CDRX on duration or not. The adjustment indication may be UE-specific or for a group of UEs that includes the UE. Accordingly, the UE may monitor during the monitoring occasions for a UE-specific communication or for a group common communication for a UE group to which the UE belongs.

By monitoring the monitoring occasions 505a, 505b, and 505c, the UE may receive the adjustment indication. In some instances, the UE may expect to receive only a single adjustment indication during the one or more monitoring occasions associated with a CDRX on-duration. Based on which monitoring occasion (e.g., monitoring occasion 505a, 505b, or 505c) the UE receives the adjustment indication in, the UE can transmit an ACK using the associated ACK resource (e.g., ACK resource 510a, 510b, or 510c). In some instances, the UE transmits the ACK using a PUCCH resource of PUCCH format 0 or PUCCH format 1. In some instances, the UE transmits the ACK based on a HARQ process associated with the resources in which the adjustment indication was received. The UE may transmit the ACK to the network unit in response to receiving the adjustment indication from a network unit (e.g., network unit 1100, BS 105, CU 210, DU 230, and/or RU 240). The UE may receive the adjustment indication from the network unit via a physical downlink control channel (PDCCH) communication and/or a physical downlink shared channel (PDSCH) communication. For example, in some instances the UE may receive the adjustment indication from the network unit via downlink control information (DCI) via a PDCCH. The DCI may be a group-common DCI or a UE-specific DCI. In some aspects, the adjustment indication may have the same and/or a similar format as a wake-up signal (WUS). In some instances, a WUS includes the adjustment indication. In some instances, the UE may receive the adjustment indication from the network unit via a media-access control control element (MAC-CE) via a PDSCH. In some aspects, the PDSCH communication may include a MAC-CE including the adjustment indication.

The adjustment indication may indicate the starting time of a CDRX on-duration and/or a length of a CDRX on-duration in any suitable manner. In some aspects, the adjustment indication indicates the nominal starting time 515 is unchanged (e.g., as shown with respect to CDRX on-durations 520a and 520c in FIG. 5). In some aspects, the adjustment indication indicates a change to the nominal starting time 515. For example, in some instances the adjustment indication may indicate the adjusted starting time 525 for the CDRX on-duration 520b as shown. The adjusted starting time 525 may be indicated as a timing offset relative to the nominal starting time 515. The timing offset may be indicated in terms of symbols, sub-slots, slots, milliseconds, microseconds, or other suitable unit of measurement. Further, the timing offset may be relative to the nominal starting time 515 of the CDRX on-duration, a reception time of the adjustment indication (e.g., the monitoring occasion 505a, 505b, or 505c in which the adjustment indication is received), and/or a transmission time of an acknowledgement (ACK) associated with the adjustment indication (e.g., the ACK resource 510a, 510b, 510c in which an ACK was transmitted).

In some aspects, the adjustment indication indicates the length of a CDRX on-duration. The length of the CDRX on-duration may be indicated in terms of symbols, sub-slots, slots, milliseconds, microseconds, or other suitable unit of measurement. In this regard, the length of the CDRX on-duration may be indicated in terms of an actual length and/or a relative length. For example, in some instances the length of the CDRX on-duration may be indicated relative to a nominal length of the CDRX on-duration. In some aspects, the adjustment indication indicates the nominal length of a CDRX on-duration is unchanged (e.g., as shown with respect to CDRX on-durations 520a and 520b in FIG. 5). In some aspects, the adjustment indication indicates a change to the nominal length of the CDRX on-duration (e.g., as shown with respect to CDRX on-duration 520c in FIG. 5, which has been lengthened relative to the nominal length). In some aspects, the adjustment indication indicates a scale to the nominal length of the CDRX on-duration (e.g., double, half, etc. of the nominal length).

The UE may monitor for a communication (e.g., one or more PDSCH communications, PDCCH communications, and/or other communications, which may include a data burst (e.g., XR data bursts 420a, 420b, 440a, 440b) associated with a data flow (e.g., XR Flow 1 405a and/or XR Flow 2 405b)) based on the starting time of the CDRX on-duration and/or the length of the CDRX on-duration indicated by the adjustment indication. For example, when the adjustment indication includes an indication of the starting time of the CDRX on-duration (e.g., drx-SlotOffset), the UE may begin monitoring for the communication based on the starting time of the CDRX on-duration as indicated by the adjustment indication, which may be the same as the nominal starting time of the CDRX on-duration (e.g., as shown by CDRX on-durations 520a and 520c) or offset from the nominal starting time of the CDRX on-duration (e.g., as shown by CDRX on-duration 520b). Similarly, when the adjustment indication includes an indication of the length of the CDRX on-duration, the UE may monitor for the communication based on the length of the CDRX on-duration as indicated by the adjustment indication, which may be the same as the nominal length of the CDRX on-duration (e.g., as shown by CDRX on-duration 520a and 520b) or different from the nominal length of the CDRX on-duration (e.g., as shown by CDRX on-duration 520c). For example, the UE may set the CDRX on-duration timer (e.g., drx-onDurationTimer) corresponding to the length the indicated CDRX on-duration. Further, when the adjustment indication includes an indication of both the starting time and the length of the CDRX on-duration, the UE may begin monitoring for the communication based on the starting time of the CDRX on-duration as indicated by the adjustment indication and monitor for the communication based on the length of the CDRX on-duration as indicated by the adjustment indication. When the adjustment indication includes an indication of the length of the CDRX on-duration but does not indicate the starting time of the CDRX on-duration the UE may begin monitoring for the communication at the nominal starting time 515 of the CDRX on-duration.

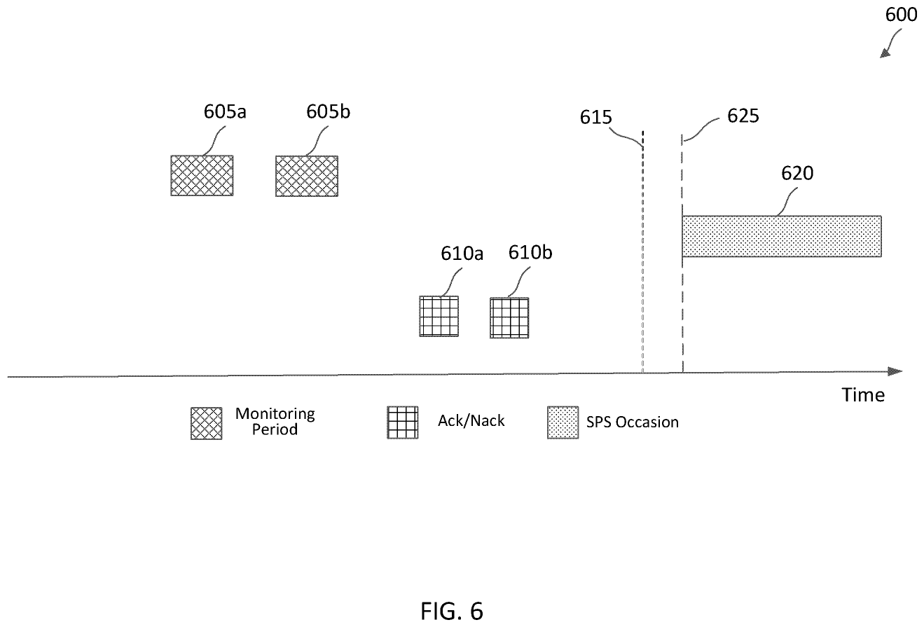

FIG. 6 illustrates a wireless communication scheme 600 according to one or more aspects of the present disclosure. In some aspects, wireless communication scheme 600 may be similar to wireless communication scheme 500, but instead of being associated with a CDRX cycle the wireless communication scheme 600 may be associated with semi-persistent scheduling (SPS). The communication scheme 600 includes monitoring occasions 605a and 605b, acknowledgement (ACK) resources 610a and 510b, a nominal starting time 615, an SPS occasion 620, and an adjusted starting time 625. In this regard, the ACK resources 610a and 610b may be respectively associated with the monitoring occasions 605a and 605b (e.g., ACK resource 610a may be associated with monitoring occasion 605a and ACK resource 610b may be associated with monitoring occasion 605b, etc.). While FIG. 6 illustrates two monitoring occasions 605a and 605b, it is understood that any suitable number of monitoring occasions may be utilized, including fewer (e.g., 1) or more (3, 4,5, 6, etc.).

A UE (e.g., UE 115 or UE 1000) may receive from a network unit a configuration or other communication indicating a location (e.g., time and/or frequency resources) of the one or more monitoring occasions 605a and 605b. The monitoring occasions 605a and 605b may occupy physical downlink control channel (PDCCH) resources and/or a physical downlink shared channel (PDSCH) resources. The UE may monitor the monitoring occasions 605a and 605b for an adjustment indication that indicates at least one of a starting time of the SPS occasion 620 and/or a length of the SPS occasion 620. The adjustment indication may be UE-specific or for a group of UEs that includes the UE. Accordingly, the UE may monitor during the monitoring occasions for a UE-specific communication or for a group common communication for a UE group to which the UE belongs.

By monitoring the monitoring occasions 605a and 605b, the UE may receive the adjustment indication. In some instances, the UE may expect to receive only a single adjustment indication during the one or more monitoring occasions associated with an SPS occasion. Based on which monitoring occasion (e.g., monitoring occasion 605a or 605b) the UE receives the adjustment indication in, the UE can transmit an ACK using the associated ACK resource (e.g., ACK resource 610a or 610b). In some instances, the UE transmits the ACK based on a HARQ process associated with the resources in which the adjustment indication was received. The UE may receive the adjustment indication from a network unit (e.g., network unit 1100, BS 105, CU 210, DU 230, and/or RU 240) and/or transmit the ACK to the network unit. The UE may receive the adjustment indication from the network unit via a physical downlink control channel (PDCCH) communication and/or a physical downlink shared channel (PDSCH) communication. For example, in some instances the UE may receive the adjustment indication from the network unit via downlink control information (DCI) via a PDCCH. The DCI may be a group-common DCI or a UE-specific DCI. In some aspects, the adjustment indication may have the same and/or a similar format as a wake-up signal (WUS). In some instances, a WUS includes the adjustment indication. In some instances, the UE may receive the adjustment indication from the network unit via a media-access control control element (MAC-CE) via a PDSCH. In some aspects, the PDSCH communication may include a MAC-CE including the adjustment indication.

The adjustment indication may indicate the starting time of the SPS occasion 620 and/or a length of the SPS occasion 620 in any suitable manner. In some aspects, the adjustment indication indicates the nominal starting time 615 is unchanged. In some aspects, the adjustment indication indicates a change to the nominal starting time 615. For example, in some instances the adjustment indication may indicate the adjusted starting time 625 for the SPS occasion 620. The adjusted starting time 625 may be indicated as a timing offset relative to the nominal starting time 615. The timing offset may be indicated in terms of symbols, sub-slots, slots, milliseconds, microseconds, or other suitable unit of measurement. Further, the timing offset may be relative to the nominal starting time 615 of the SPS occasion 620, a reception time of the adjustment indication (e.g., the monitoring occasion 605a or 605b in which the adjustment indication is received), and/or a transmission time of an acknowledgement (ACK) associated with the adjustment indication (e.g., the ACK resource 610a or 610b in which an ACK was transmitted).

In some aspects, the adjustment indication indicates the length of the SPS occasion 620. The length of the SPS occasion 620 may be indicated in terms of symbols, sub-slots, slots, milliseconds, microseconds, or other suitable unit of measurement. In this regard, the length of the SPS occasion 620 may be indicated in terms of an actual length and/or a relative length. For example, in some instances the length of the SPS occasion 620 may be indicated relative to a nominal length of the SPS occasion 620. In some aspects, the adjustment indication indicates the nominal length of the SPS occasion 620 is unchanged. In some aspects, the adjustment indication indicates a change to the nominal length of the SPS occasion 620.

The UE may monitor for a communication (e.g., one or more PDSCH communications, PDCCH communications, and/or other communications, which may include a data burst (e.g., XR data bursts 420a, 420b, 440a, 440b) associated with a data flow (e.g., XR Flow 1 405a and/or XR Flow 2 405b)) based on the starting time of the SPS occasion 620 and/or the length of the SPS occasion 620 as indicated by the adjustment indication. For example, when the adjustment indication includes an indication of the starting time of the SPS occasion 620, the UE may begin monitoring for the communication based on the starting time of the SPS occasion 620 as indicated by the adjustment indication, which may be the same as the nominal starting time 615 of the SPS occasion 620 or offset from the nominal starting time 615 of the SPS occasion (e.g., as shown in FIG. 6). Similarly, when the adjustment indication includes an indication of the length of the SPS occasion 620, the UE may monitor for the communication based on the length of the SPS occasion 620 as indicated by the adjustment indication, which may be the same as the nominal length of the SPS occasion 620 or different from the nominal length of the SPS occasion 620. Further, when the adjustment indication includes an indication of both the starting time and the length of the SPS occasion 620, the UE may begin monitoring for the communication based on the starting time of the SPS occasion 620 as indicated by the adjustment indication and monitor for the communication based on the length of the SPS occasion 620 as indicated by the adjustment indication. When the adjustment indication includes an indication of the length of the SPS occasion 620 but does not indicate the starting time of the SPS occasion 620 the UE may begin monitoring for the communication at the nominal starting time 615 of the SPS occasion 620.

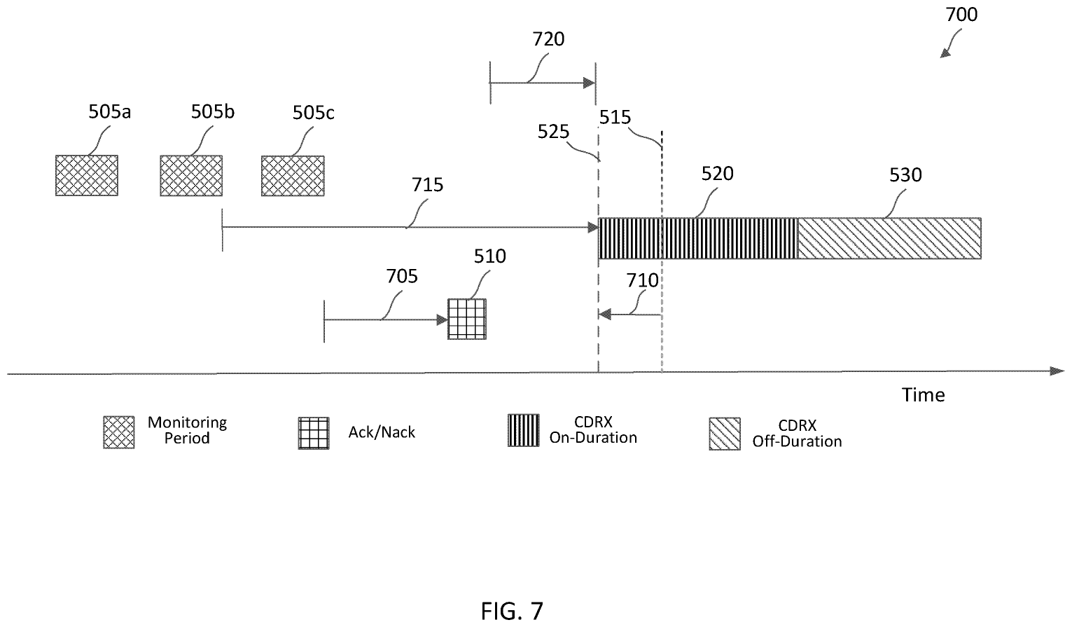

FIG. 7 illustrates a wireless communication scheme 700 according to one or more aspects of the present disclosure. In some aspects, wireless communication scheme 700 may include aspects similar to wireless communication schemes 500 and 600 above. In this regard, the same reference numerals are utilized in the context of FIG. 7 to refer to the same or similar features as described above with respect to FIG. 5 and wireless communication scheme 500 and, therefore, the descriptions will not be repeated here. It is also understood that the concepts described with respect to FIG. 7 in the context of CDRX are similarly applicable to SPS scenarios.

Again, the UE may monitor the monitoring occasions 505a, 505b, and 505c for an adjustment indication. However, in contrast to wireless communication scheme 500, regardless of which monitoring occasion (e.g., monitoring occasion 505a, 505b, or 505c) the UE receives the adjustment indication in, the UE transmits an ACK using a common ACK resource 510. That is, if the UE receives the adjustment indication during any of monitoring occasions 505a, 505b, or 505c, the UE uses the common ACK resource 510 to transmit the ACK. In some instances, the common ACK resource 510 is spaced from the last monitoring occasion (e.g., monitoring occasion 505c) by a time offset 705. In some instances, the time offset 705 may be a fixed offset (e.g., a number of slots such as K0 or K1 indicated by the DCI). In some instances, the location of the ACK resource 510 and or the time offset 705 may be selected to ensure that the ACK resource 510 occupies resources intended for uplink communications. For example, the location of the ACK resource 510 may be a valid uplink slot (as opposed to a valid downlink slot). In some instances, the common ACK resource 510 may be ahead of the starting time of the CDRX on-duration by a time offset 705, where the starting time of the CDRX on-duration may be a nominal starting time or an indicated starting tome. In some instances, the common ACK resource 510 may be after the starting time of the CDRX on-duration by a time offset 705, where the starting time of the CDRX on-duration may be a nominal starting time or an indicated starting time. In some instances, the common ACK resource 510 is in a first uplink slot after the starting time of the CDRX on-duration. In some instances, the time offset 705 may be a fixed offset (e.g., a number of slots such as K0 or K1 indicated by the DCI). In some instances, the location of the ACK resource 510 and/or the time offset 705 may be selected to ensure that the ACK resource 510 occupies resources intended for uplink communications. In some instances, the UE receives an indication of the time offset 705 from a network unit. In some instances, the time offset 705 may be indicated in the same communication indicating a location (e.g., time and/or frequency resources) of the one or more monitoring occasions 505a, 505b, and 505c. In some instances, the time offset 705 may be indicated to the UE in a separate communication.

As discussed above, the adjustment indication may indicate the starting time of a CDRX on-duration in any suitable manner. The wireless communication scheme 700 of FIG. 7 illustrates some of the options for indicating the starting time of the CDRX on-duration 520. In some aspects, the adjustment indication indicates the nominal starting time 515 is unchanged. In some aspects, the adjustment indication indicates a change to the nominal starting time 515. For example, in some instances the adjustment indication may indicate the adjusted starting time 525 for the CDRX on-duration 520 as shown. The adjusted starting time 525 may be indicated as a timing offset. The timing offset may be indicated in terms of symbols, sub-slots, slots, milliseconds, microseconds, or other suitable unit of measurement. Further, the timing offset may be relative to the nominal starting time 515 of the CDRX on-duration 520 as shown by timing offset 710. The timing may also be relative to a reception time of the adjustment indication (e.g., the monitoring occasion 505b in which the adjustment indication is received) as shown by timing offset 715. The timing may also be relative to a transmission time of the ACK associated with the adjustment indication (e.g., the ACK resource 510 in which an ACK was transmitted).

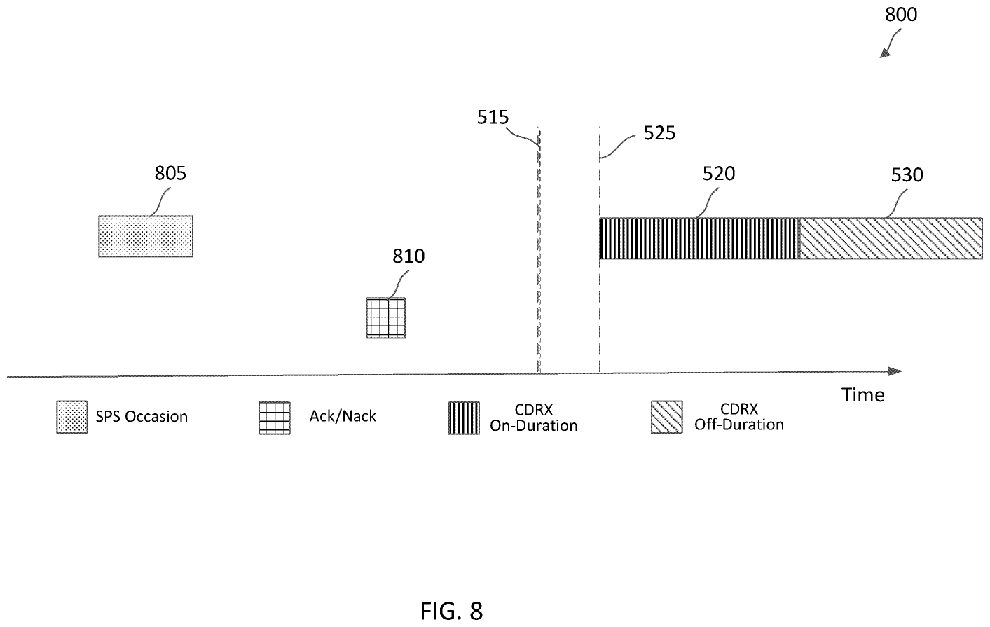

FIG. 8 illustrates a wireless communication scheme 800 according to one or more aspects of the present disclosure. In some aspects, wireless communication scheme 800 may include aspects similar to wireless communication schemes 500, 600, and 700 above. In this regard, the same reference numerals are utilized in the context of FIG. 8 to refer to the same or similar features as described above with respect to FIG. 5 and wireless communication scheme 500 and, therefore, the descriptions will not be repeated here.

As discussed above, a UE (e.g., UE 115 or UE 1000) may receive from a network unit a configuration or other communication indicating a location (e.g., time and/or frequency resources) of one or more monitoring occasions. The monitoring occasion(s) may occupy physical downlink control channel (PDCCH) resources and/or a physical downlink shared channel (PDSCH) resources. In some aspects, the monitoring occasion(s) include one or more SPS occasions (e.g., SPS occasion 805). In some instances, the one or more SPS occasions are associated with a CDRX cycle. For example, the one or more SPS occasions may occur prior to a CDRX on-duration 520 (e.g., prior to the nominal starting time 515 of the CDRX on-duration). In this manner, the SPS occasion(s) may be utilized to communicate an adjustment indication. The UE may monitor the SPS occasion 805 for the adjustment indication that indicates at least one of a starting time of the CDRX on-duration 520 and/or a length of the CDRX on-duration 520.

By monitoring the SPS occasion 805, the UE may receive the adjustment indication. The UE may transmit an ACK using an associated ACK resource 810. The ACK resource 810 may be associated with a single SPS occasion (e.g., similar to FIG. 5) and/or multiple SPS occasions (e.g., similar to FIG. 7). In some instances, the UE may receive the adjustment indication from the network unit via a media-access control control element (MAC-CE) via a PDSCH communication of the SPS occasion 805. In some instances, the adjustment indication carried by the MAC-CE indicates at least one of a timing offset for the start of the CDRX on-duration 520 (e.g., indicating the adjusted starting time 525) and/or the length of the CDRX on-duration 520. In some instances, the PDSCH communication may be associated with the SPS occasion 805. In this regard, in some aspects the PDSCH communication of the SPS occasion 805 may include a MAC-CE carrying the adjustment indication and the adjustment indication may include an indication of a starting time of the CDRX on-duration 520 for the CDRX cycle associated with the SPS occasion 805. In some instances, the UE receives the adjustment indication by monitoring a PDSCH for the adjustment indication during one or more scheduled downlink communication occasions, which may include an SPS occasion (e.g., SPS occasion 805).

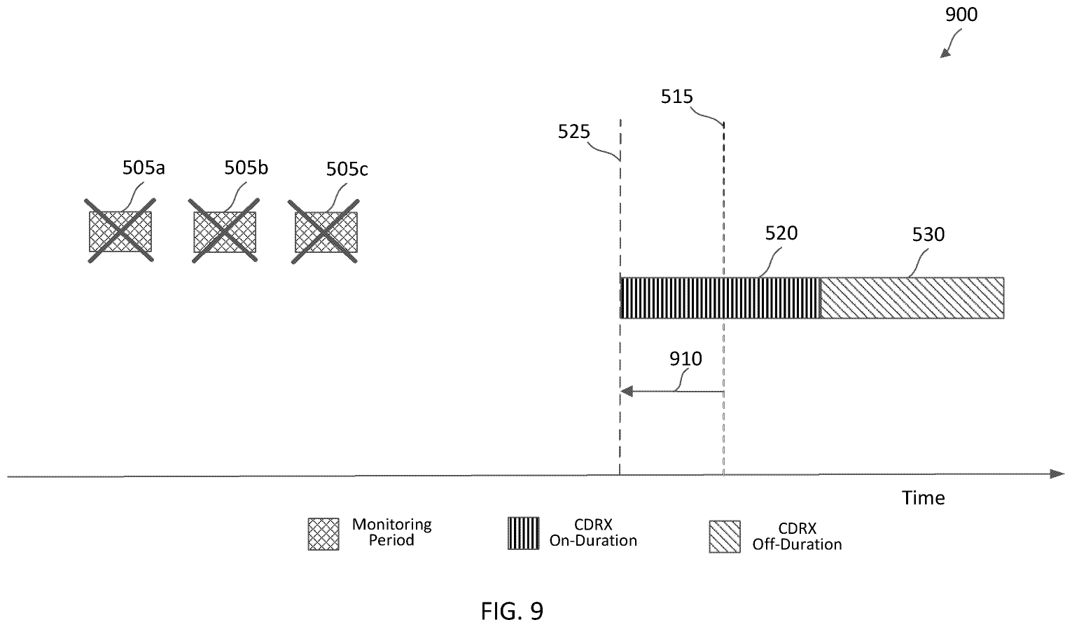

FIG. 9 illustrates a wireless communication scheme 900 according to one or more aspects of the present disclosure. In some aspects, wireless communication scheme 900 may include aspects similar to the wireless communication schemes 500, 600, 700, and 800 above. In this regard, the same reference numerals are utilized in the context of FIG. 9 to refer to the same or similar features as described above with respect to FIG. 5 and wireless communication scheme 500 and, therefore, the descriptions will not be repeated here. In some instances, the wireless communication scheme 900 may be used in combination with aspects of the wireless communication schemes 500, 600, 700, and 800. It is also understood that the concepts described with respect to FIG. 9 in the context of CDRX are similarly applicable to SPS scenarios.

The UE may monitor for an adjustment indication and/or wake-up signal during one or more monitoring occasions (e.g., monitoring occasions 505a, 505b, and 505c) associated with a CDRX on-duration (e.g., CDRX on-duration 520). As shown, in wireless communication scheme 900, the UE does not receive the adjustment indication/WUS in any of the monitoring occasions 505a, 505b, and 505c (as indicated by the “X” through each of the monitoring occasions 505a, 505b, and 505c).

Based on failing to receive the adjustment indication/WUS during the one or more monitoring occasions 505a, 505b, or 505c, the UE may monitor for a communication associated with a data flow during the CDRX on-duration. The UE may monitor for the communication using an adjusted starting time 525 of the CDRX on-duration based on the nominal starting time 515 of the CDRX on-duration and a jitter of the data flow (e.g., maximum jitter, a median jitter, an average jitter, etc.). That is, the UE may determine the adjusted starting time 525 for the CDRX on-duration 520 by adjusting the nominal starting time 515 of the CDRX on-duration 520 based on the maximum jitter of the data flow, as indicated by offset 910. That is, the UE may adjust the nominal starting time 515 by the offset 910 to reach the adjusted starting time 525, which may be before the nominal starting time (as shown in FIG. 9) and/or after the nominal starting time. For example, in some instances the UE may determine the adjusted starting time 525 of the CDRX on-duration 520 by adding or subtracting time relative to the nominal starting time 515 of the CDRX on-duration based on the maximum jitter of a data flow. Accordingly, the determined adjusted starting time may be the same as the nominal starting time (e.g., when the data flow has no jitter or minimal jitter) or offset from the nominal starting time (e.g., when the data flow has jitter). The UE may monitor for the communication beginning at the determined starting time (e.g., the adjusted starting time 525) for the CDRX on-duration 520.

In some aspects, the UE may receive an indication of the jitter of the data flow (e.g., maximum jitter, a median jitter, an average jitter, etc.). The UE may receive the indication of the jitter from the network unit. The indication of the jitter may be an explicit indication or an implicit indication. For example, the UE may receive an explicit indication of the jitter (e.g., a maximum jitter measurement, a median jitter measurement, an average jitter measurement, etc.) from the network unit. The network unit may provide the explicit indication of the jitter to the UE to allow the UE to adjust the nominal starting time 515 for one or more CDRX on-duration(s) when no adjustment indication is provided and/or for other communication purposes. In some aspects, the UE may utilize information regarding jitter received by one or more a higher layer(s) of the UE to determine the jitter parameter and/or the associated offset 910 utilized to adjust the nominal starting time 515 of the CDRX on-duration 520. In some instances, the indication of the jitter may be an implicit indication. For example, the UE may receive from the network unit an indication of one or more higher layer parameters associated with the communication flow that may be utilized by the UE to determine the jitter parameter and/or the associated offset 910 utilized to adjust the starting time of the CDRX on-duration 520. The UE may receive the explicit and/or implicit indication of jitter via an RRC communication, a PDCCH communication, a PDSCH communication, and/or other suitable communication.

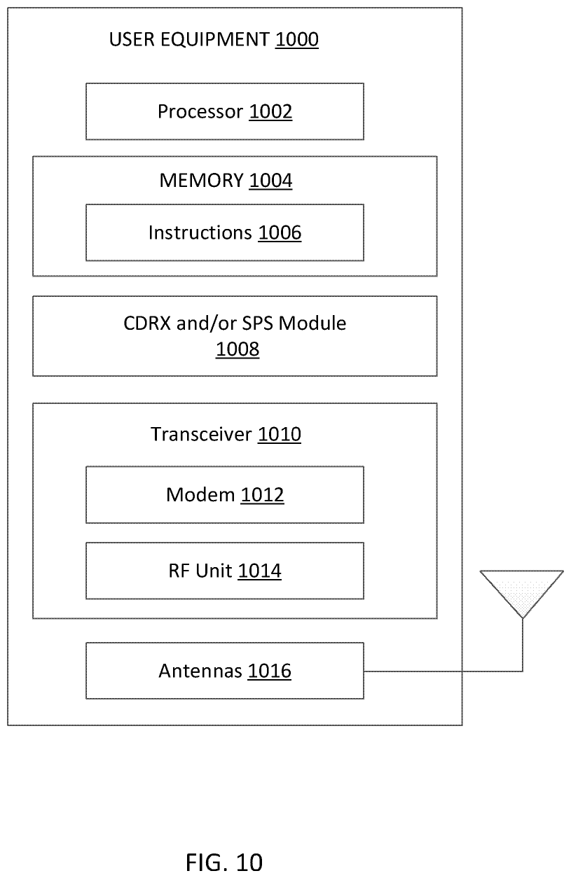

FIG. 10 is a block diagram of a UE 1000 according to one or more aspects of the present disclosure. The UE 1000 may be, for instance, a UE 115 as discussed in FIGS. 1-9. As shown, the UE 1000 may include a processor 1002, a memory 1004, a CDRX and/or SPS module 1008, a transceiver 1010 including a modem subsystem 1012 and an RF unit 1014, and one or more antennas 1016. These elements may be coupled with one another. The term “coupled” may refer to directly or indirectly coupled or connected to one or more intervening elements. For instance, these elements may be in direct or indirect communication with each other, for instance via one or more buses.

The processor 1002 may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, solid state memory device, hard disk drives, other forms of volatile and non-volatile memory, or a combination of different types of memory. In an aspect, the memory 1004 includes a non-transitory computer-readable medium. The memory 1004 may store, or have recorded thereon, instructions 1006. The instructions 1006 may include instructions that, when executed by the processor 1002, cause the processor 1002 to perform the operations described herein with reference to a UE 115 in connection with aspects of the present disclosure, for instance, aspects of FIGS. 4-9, 12 and 14. Instructions 1006 may also be referred to as code, which may be interpreted broadly to include any type of computer-readable statement(s) as discussed above with respect to FIGS. 4-9, 12, and 14.

The CDRX and/or SPS module 1008 may be implemented via hardware, software, or combinations thereof. For instance, the CDRX and/or SPS module 1008 may be implemented as a processor, circuit, and/or instructions 1006 stored in the memory 1004 and executed by the processor 1002. In some aspects, the CDRX and/or SPS module 1008 can be integrated within the modem subsystem 1012. For instance, the CDRX and/or SPS module 1008 can be implemented by a combination of software components (e.g., executed by a DSP or a general processor) and hardware components (e.g., logic gates and circuitry) within the modem subsystem 1012. The CDRX and/or SPS module 1008 may communicate with one or more components of the UE 1000 to implement various aspects of the present disclosure, for instance, aspects of FIGS. 4-9, 12, and 14.

In some aspects, the CDRX and/or SPS module 1008 may be configured, along with other components of the UE 1000, to receive an adjustment indication indicating at least one of a starting time of a connected discontinuous reception (CDRX) on-duration, a length of a CDRX on-duration, a starting time of a semi-persistent scheduling (SPS) occasion, and/or a length of an SPS occasion. In some aspects, the CDRX and/or SPS module 1008 may be configured, along with other components of the UE 1000, to transmit an acknowledgment (ACK) associated with the adjustment indication. In some aspects, the CDRX and/or SPS module 1008 may be configured, along with other components of the UE 1000, to monitor, based on the at least one of the starting time of the CDRX on-duration, the length of the CDRX on-duration, the starting time of SPS occasion, and/or the length of the SPS occasion, for a communication.

As shown, the transceiver 1010 may include the modem subsystem 1012 and the RF unit 1014. The transceiver 1010 can be configured to communicate bi-directionally with other devices, such as the BSs 105 and/or network units. The modem subsystem 1012 may be configured to modulate and/or encode the data from the memory 1004 and/or the CDRX and/or SPS module 1008 according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data (e.g., communication signals, data signals, control signals, acknowledgements (ACKs), etc.) from the modem subsystem 1012 (on outbound transmissions). The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the UE 1000 to enable the UE 1000 to communicate with other devices.

The RF unit 1014 may provide the modulated and/or processed data, e.g., data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The transceiver 1010 may provide the demodulated and decoded data (e.g., communication signals, data signals, control signals, wake-up signals, adjustment indications, CDRX communications, SPS communications, etc.) to the CDRX and/or SPS module 1008 for processing. The antennas 1016 may include multiple antennas of similar or different designs in order to sustain multiple transmission links.

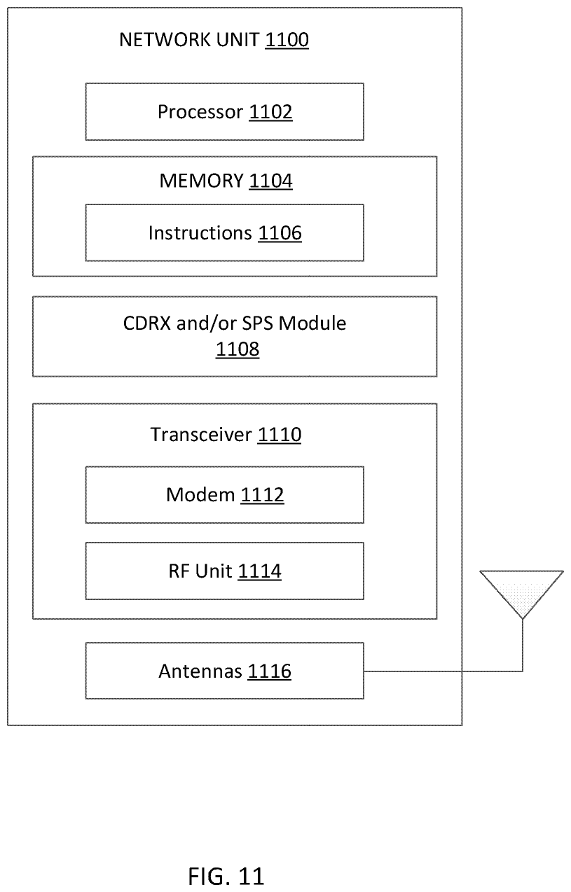

FIG. 11 is a block diagram of a network unit 1100 according to one or more aspects of the present disclosure. The network unit 1100 may be a BS 105, DU 240, and/or CU 230 as discussed in FIGS. 1-9. Accordingly, the network unit 1100 may include a BS. The BS may be an aggregated BS or a disaggregated BS, as described above. As shown, the network unit 1100 may include a processor 1102, a memory 1104, a CDRX and/or SPS module 1108, a transceiver 1110 including a modem subsystem 1112 and a radio frequency (RF) unit 1114, and one or more antennas 1116. These elements may be coupled with one another. The term “coupled” may refer to directly or indirectly coupled or connected to one or more intervening elements. For instance, these elements may be in direct or indirect communication with each other, for instance via one or more buses.

The processor 1102 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the network unit 1100 to perform operations described herein, for instance, aspects of FIGS. 4-9 and 13. Instructions 1106 may also be referred to as program code. The program code may be for causing a wireless communication device to perform these operations, for instance by causing one or more processors (such as processor 1102) to control or command the wireless communication device to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The CDRX and/or SPS module 1108 may be implemented via hardware, software, or combinations thereof. For instance, the CDRX and/or SPS module 1108 may be implemented as a processor, circuit, and/or instructions 1106 stored in the memory 1104 and executed by the processor 1102. In some instances, the CDRX and/or SPS module 1108 can be integrated within the modem subsystem 1112. For instance, the CDRX and/or SPS module 1108 can be implemented by a combination of software components (e.g., executed by a DSP or a general processor) and hardware components (e.g., logic gates and circuitry) within the modem subsystem 1112. The CDRX and/or SPS module 1108 may communicate with one or more components of the network unit 1100 to implement various aspects of the present disclosure, for instance, aspects of FIGS. 4-9 and 13.

In some aspects, the CDRX and/or SPS module 1108 may be configured, along with other components of the network unit 1100, to transmit an adjustment indication indicating at least one of a starting time of a connected discontinuous reception (CDRX) on-duration, a length of a CDRX on-duration, a starting time of a semi-persistent scheduling (SPS) occasion, and/or a length of an SPS occasion. In some aspects, the CDRX and/or SPS module 1108 may be configured, along with other components of the network unit 1100, to receive an acknowledgment (ACK) associated with the adjustment indication. In some aspects, the CDRX and/or SPS module 1108 may be configured, along with other components of the network unit 1100, to transmit, based on the at least one of the starting time of the CDRX on-duration, the length of the CDRX on-duration, the starting time of SPS occasion, and/or the length of the SPS occasion, for a communication.

As shown, the transceiver 1110 may include the modem subsystem 1112 and the RF unit 1114. The transceiver 1110 can be configured to communicate bi-directionally with other devices, such as the UE 115, UE 1000, and/or another network unit. The modem subsystem 1112 may be configured to modulate and/or encode data according to a modulation and coding scheme (MCS), e.g., a low-density parity check (LDPC) coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (e.g., communication signals, data signals, control signals, wake-up signals, adjustment indications, CDRX communications, SPS communications, etc.) from the modem subsystem 1112 (on outbound transmissions). The RF unit 1114 may be further configured to perform analog beamforming in conjunction with the digital beamforming. Although shown as integrated together in transceiver 1110, the modem subsystem 1112, and/or the RF unit 1114 may be separate devices that are coupled together at the network unit 1100 to enable the network unit 1100 to communicate with other devices.

The RF unit 1114 may provide the modulated and/or processed data, e.g., data packets (or, more generally, data messages that may contain one or more data packets and other information), to the antennas 1116 for transmission to one or more other devices. The antennas 1116 may further receive data messages transmitted from other devices and provide the received data messages for processing and/or demodulation at the transceiver 1110. The transceiver 1110 may provide the demodulated and decoded data (e.g., communication signals, data signals, control signals, acknowledgements (ACKs), etc.) to the CDRX and/or SPS module 1108 for processing. The antennas 1116 may include multiple antennas of similar or different designs in order to sustain multiple transmission links.

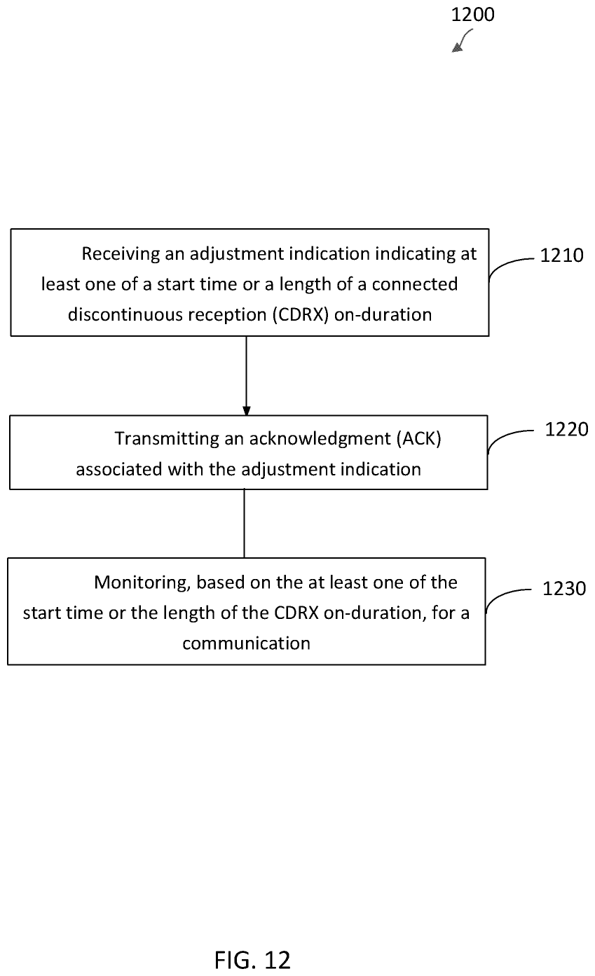

FIG. 12 is a flow diagram illustrating a wireless communication method 1200 according to one or more aspects of the present disclosure. Aspects of the method 1200 can be executed by a computing device (e.g., a processor, processing circuit, and/or other suitable component) of a wireless communication device or other suitable means for performing the blocks. For instance, the wireless communication device may be a UE (e.g., UE 115 or UE 1000). The UE may utilize one or more components, such as the processor 1002, the memory 1004, the CDRX and/or SPS module 1008, the transceiver 1010, the modem 1012, the RF unit 1014, and/or the one or more antennas 1016, to execute the blocks of method 1200. The method 1200 may employ similar mechanisms as described in FIGS. 4-9. As illustrated, the method 1200 includes a number of enumerated blocks, but aspects of the method 1200 may include additional blocks before, after, and in between the enumerated blocks. In some aspects, one or more of the enumerated blocks may be omitted or performed in a different order.

At block 1210, the UE (e.g., UE 115 and/or UE 1000) receives an adjustment indication indicating at least one of a starting time of a connected discontinuous reception (CDRX) on-duration, a length of a CDRX on-duration, a starting time of a semi-persistent scheduling (SPS) occasion, and/or a length of an SPS occasion. The adjustment indication may be UE-specific or for a group of UEs that includes the UE.

The UE may receive the adjustment indication from a network unit (e.g., network unit 1100, BS 105, CU 210, DU 230, and/or RU 240). The UE may receive the adjustment indication from the network unit via a physical downlink control channel (PDCCH) communication and/or a physical downlink shared channel (PDSCH) communication. For example, in some instances the UE may receive the adjustment indication from the network unit via downlink control information (DCI) via a PDCCH. The DCI may be a group-common DCI or a UE-specific DCI. In some aspects, the adjustment indication may have the same and/or a similar format as a wake-up signal (WUS). In some instances, a WUS includes the adjustment indication. In some instances, the UE may receive the adjustment indication from the network unit via a media-access control control element (MAC-CE) via a PDSCH. In some aspects, the PDSCH communication may include a MAC-CE including the adjustment indication. In some instances, the adjustment indication carried by the MAC-CE indicates at least one of a timing offset for the start of the CDRX on-duration and/or the length of the CDRX on-duration. In some instances, the PDSCH communication may be associated with an SPS occasion associated with a CDRX cycle (e.g., as shown in FIG. 8). In this regard, in some aspects the PDSCH communication of the SPS occasion may include a MAC-CE carrying the adjustment indication, wherein the adjustment indication includes an indication of a starting time of the CDRX on-duration for the CDRX cycle associated with the SPS.

In some instances, the UE receives the adjustment indication by monitoring a physical downlink control channel (PDCCH) for the adjustment indication during one or more monitoring occasions (e.g., as shown in FIGS. 5, 6, 7, and 9). The UE may receive from a network unit a configuration indicating a location (e.g., time and/or frequency resources) of the one or more monitoring occasions. In some instances, the UE receives the adjustment indication by monitoring a physical downlink shared channel (PDSCH) for the adjustment indication during one or more scheduled downlink communication occasions, which may include an SPS occasion (e.g., as shown in FIG. 8).

The adjustment indication may indicate the starting time a CDRX on-duration, a length of a CDRX on-duration, a starting time of an SPS occasion, and/or a length of an SPS occasion in any suitable manner. In some aspects, the adjustment indication indicates the starting time of a CDRX on-duration as a timing offset associated with the starting time of the CDRX on-duration. The timing offset may be indicated in terms of symbols, sub-slots, slots, milliseconds, microseconds, or other suitable unit of measurement. In this regard, the timing offset may be relative to a nominal starting time of the CDRX on-duration (e.g., as indicated in FIG. 7 by timing offset 710), a reception time of the adjustment indication (e.g., as indicated in FIG. 7 by timing offset 715), and/or a transmission time of an acknowledgement (ACK) associated with the adjustment indication (e.g., as indicated in FIG. 7 by timing offset 720).

In some aspects, the adjustment indication indicates the length of a CDRX on-duration. The length of the CDRX on-duration may be indicated in terms of symbols, sub-slots, slots, milliseconds, microseconds, or other suitable unit of measurement. In this regard, the length of the CDRX on-duration may be indicated in terms of an actual length and/or a relative length. For example, in some instances the length of the CDRX on-duration may be indicated relative to a nominal length of the CDRX on-duration.

In some aspects, the adjustment indication indicates the starting time of an SPS occasion as a timing offset associated with the starting time of the SPS occasion. The timing offset may be indicated in terms of symbols, sub-slots, slots, milliseconds, microseconds, or other suitable unit of measurement. In this regard, the timing offset may be relative to a nominal starting time of the SPS occasion, a reception time of the adjustment indication, and/or a transmission time of an acknowledgement (ACK) associated with the adjustment indication.

In some aspects, the adjustment indication indicates the length of an SPS occasion. The length of the SPS occasion may be indicated in terms of symbols, sub-slots, slots, milliseconds, microseconds, or other suitable unit of measurement. In this regard, the length of the SPS occasion may be indicated in terms of an actual length and/or a relative length. For example, in some instances the length of the SPS occasion may be indicated relative to a nominal length of the SPS occasion.

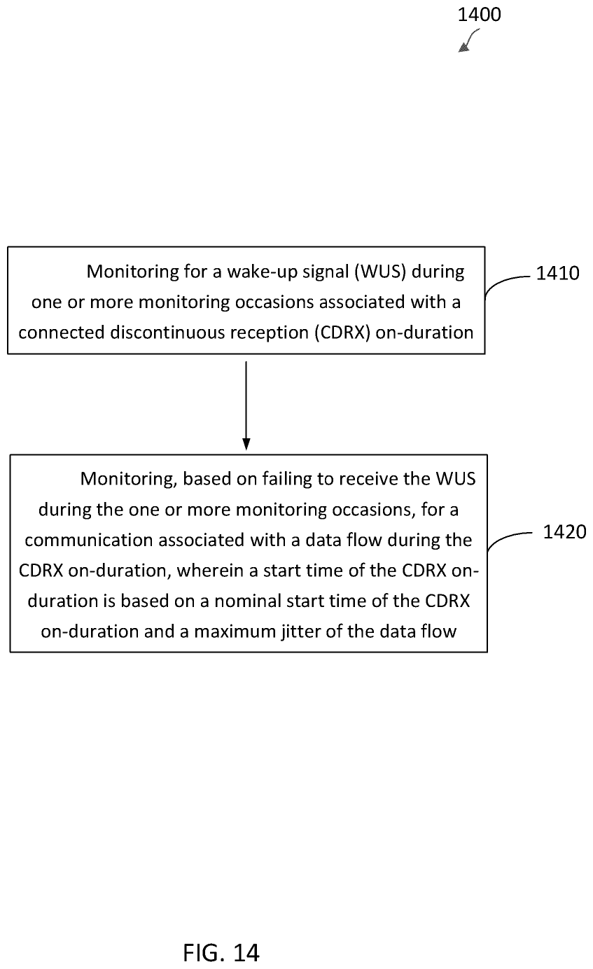

At block 1220, the UE transmits an acknowledgment (ACK) associated with the adjustment indication (e.g., as shown in FIGS. 5-8). The UE may transmit the ACK to the network unit that the UE received the adjustment indication from. In some instances, the UE transmits the ACK using PUCCH format 0 or PUCCH format 1. In some instances, the UE transmits the ACK based on when the UE receives the adjustment indication and/or the network unit transmits the adjustment indication (e.g., based on a HARQ process associated with the resources in which the adjustment indication was received). In some instances, the UE transmits the ACK in a time period spaced by a timing offset from a last monitoring occasion of one or more monitoring occasions (e.g., as shown in FIG. 7). That is, the UE may monitor for the adjustment indication in the one or more monitoring occasions and if the UE receives the adjustment indication in any of the monitoring occasions, the UE transmits the ACK using the same resources spaced from the last monitoring occasion regardless of which monitoring occasion the adjustment indication was received in. For power savings, processing savings, and/or efficient utilization of network resources, the UE may refrain from transmitting a negative acknowledgement (NACK) when the UE fails to receive an adjustment indication during any of the monitoring occasions. As discussed further in the context of FIGS. 9 and 14, in some instances when the UE does not receive an adjustment indication and/or a WUS for a CDRX on-duration, then the UE may adjust the starting time of the CDRX on-duration based on the jitter of a data flow (e.g., XR Flow 1 405a and/or XR Flow 2 405b of FIG. 4) associated with the CDRX on-duration.

At block 1230, the UE monitors for a communication based on the starting time of the CDRX on-duration, the length of the CDRX on-duration, the starting time of the SPS occasion, and/or the length of the SPS occasion indicated by the adjustment indication. For example, when the adjustment indication includes an indication of the starting time of the CDRX on-duration, the UE may begin monitoring for the communication based on the starting time of the CDRX on-duration as indicated by the adjustment indication, which may be offset from the nominal starting time of the CDRX on-duration. Similarly, when the adjustment indication includes an indication of the length of the CDRX on-duration, the UE may monitor for the communication based on the length of the CDRX on-duration as indicated by the adjustment indication, which may be different from the nominal length of the CDRX on-duration. Further, when the adjustment indication includes an indication of both the starting time and the length of the CDRX on-duration, the UE may begin monitoring for the communication based on the starting time of the CDRX on-duration as indicated by the adjustment indication and monitor for the communication based on the length of the CDRX on-duration as indicated by the adjustment indication. When the adjustment indication includes an indication of the length of the CDRX on-duration but does not indicate the starting time of the CDRX on-duration the UE may begin monitoring for the communication at the nominal starting time of the CDRX on-duration.

When the adjustment indication includes an indication of the starting time of the SPS occasion, the UE may begin monitoring for the communication based on the starting time of the SPS occasion as indicated by the adjustment indication, which may be offset from the nominal starting time of the SPS occasion. Similarly, when the adjustment indication includes an indication of the length of the SPS occasion, the UE may monitor for the communication based on the length of the SPS occasion as indicated by the adjustment indication, which may be different from the nominal length of the SPS occasion. Further, when the adjustment indication includes an indication of both the starting time and the length of the SPS occasion, the UE may begin monitoring for the communication based on the starting time of the SPS occasion as indicated by the adjustment indication and monitor for the communication based on the length of the SPS occasion as indicated by the adjustment indication. When the adjustment indication includes an indication of the length of the SPS occasion but does not indicate the starting time of the SPS occasion the UE may begin monitoring for the communication at the nominal starting time of the SPS occasion.

In some aspects, the UE receives the communication based on the monitoring at block 1230. The communication may include one or more PDSCH communications, PDCCH communications, and/or other communications. In some instances, the communication includes a data burst (e.g., XR data bursts 420a, 420b, 440a, 440b of FIG. 4) associated with a data flow (e.g., XR Flow 1 405a and/or XR Flow 2 405b of FIG. 4).

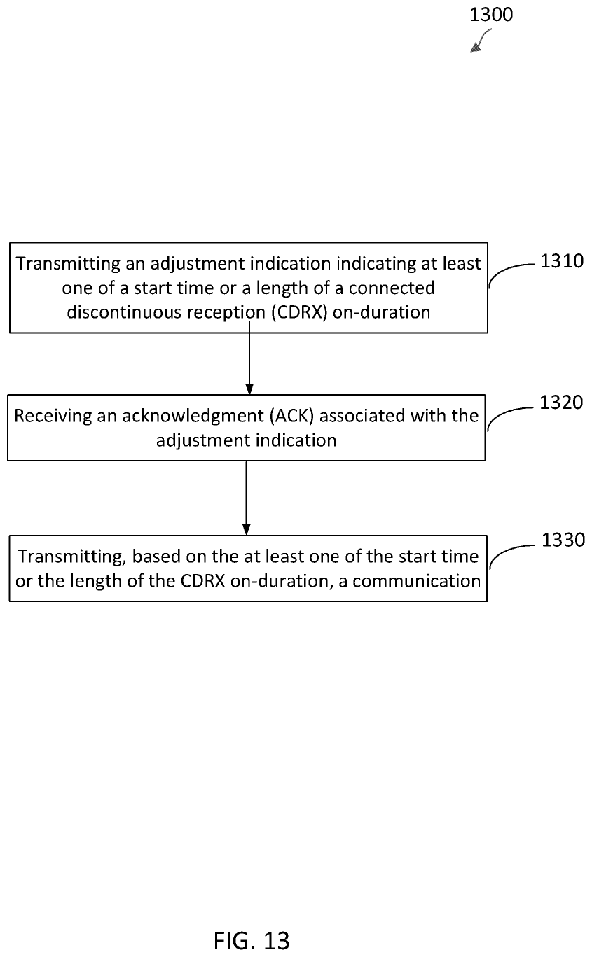

FIG. 13 is a flow diagram illustrating a wireless communication method 1300 according to one or more aspects of the present disclosure. Aspects of the method 1300 can be executed by a computing device (e.g., a processor, processing circuit, and/or other suitable component) of a wireless communication device or other suitable means for performing the blocks. For instance, the wireless communication device may include a network unit (e.g., network unit 1100, BS 105, CU 210, DU 230, and/or RU 240). The network unit 1100 may utilize one or more components, such as the processor 1102, the memory 1104, the CDRX and/or SPS module 1108, the transceiver 1110, the modem 1112, the RF unit 1114, and/or the one or more antennas 1116, to execute the blocks of method 1300. The method 1300 may employ similar mechanisms as described in FIGS. 4-9. As illustrated, the method 1300 includes a number of enumerated blocks, but aspects of the method 1300 may include additional blocks before, after, and in between the enumerated blocks. In some aspects, one or more of the enumerated blocks may be omitted or performed in a different order.

At block 1310, the network unit (network unit 1100, BS 105, CU 210, DU 230, and/or RU 240) transmits an adjustment indication indicating at least one of a starting time of a connected discontinuous reception (CDRX) on-duration, a length of a CDRX on-duration, a starting time of a semi-persistent scheduling (SPS) occasion, and/or a length of an SPS occasion. The network unit may transmit the adjustment indication to a UE (e.g., UE 115 and/or UE 1000). The adjustment indication may be UE-specific or for a group of UEs that includes the UE. The network unit may transmit the adjustment indication to the UE via a physical downlink control channel (PDCCH) communication and/or a physical downlink shared channel (PDSCH) communication. For example, in some instances the network unit may transmit the adjustment indication to the UE via downlink control information (DCI) via a PDCCH. The DCI may be a group-common DCI or a UE-specific DCI. In some aspects, the adjustment indication may have the same and/or a similar format as a wake-up signal (WUS). In some instances, a WUS includes the adjustment indication. In some instances, the network unit may transmit the adjustment indication to the UE via a media-access control control element (MAC-CE) via a PDSCH. In some aspects, the PDSCH communication may include a MAC-CE including the adjustment indication. In some instances, the adjustment indication carried by the MAC-CE indicates at least one of a timing offset for the start of the CDRX on-duration and/or the length of the CDRX on-duration. In some instances, the PDSCH communication may be associated with an SPS occasion associated with a CDRX cycle (e.g., as shown in FIG. 8). In this regard, in some aspects the PDSCH communication of the SPS occasion may include a MAC-CE carrying the adjustment indication, wherein the adjustment indication includes an indication of a starting time of the CDRX on-duration for the CDRX cycle associated with the SPS.

In some instances, the network unit transmits the adjustment indication during one or more monitoring occasions of the UE (e.g., as shown in FIGS. 5, 6, 7, and 9). The network unit may schedule the transmission of the adjustment indication to align with a monitoring occasion of the UE. Further, the network unit may transmit to a UE a configuration indicating a location (e.g., time and/or frequency resources) of the one or more monitoring occasions. In some instances, the network unit transmits the adjustment indication via a physical downlink shared channel (PDSCH) during one or more scheduled downlink communication occasions, which may include an SPS occasion (e.g., as shown in FIG. 8).

The adjustment indication transmitted by the network unit indicates the starting time a CDRX on-duration, a length of a CDRX on-duration, a starting time of an SPS occasion, and/or a length of an SPS occasion in any suitable manner. In some aspects, the adjustment indication indicates the starting time of a CDRX on-duration as a timing offset associated with the starting time of the CDRX on-duration. The timing offset may be indicated in terms of symbols, sub-slots, slots, milliseconds, microseconds, or other suitable unit of measurement. In this regard, the timing offset may be relative to a nominal starting time of the CDRX on-duration (e.g., as indicated in FIG. 7 by timing offset 710), a reception time of the adjustment indication (e.g., as indicated in FIG. 7 by timing offset 715), and/or a transmission time of an acknowledgement (ACK) associated with the adjustment indication (e.g., as indicated in FIG. 7 by timing offset 720).

In some instances, the network unit determines the starting time of a CDRX on-duration, the length of a CDRX on-duration, the starting time of an SPS occasion, and/or the length of an SPS occasion. The network unit may determine the starting time of a CDRX on-duration, the length of a CDRX on-duration, the starting time of an SPS occasion, and/or the length of an SPS occasion based on jitter associated with a data flow (e.g., XR Flow 1 405a and/or XR Flow 2 405b of FIG. 4) and/or one or more other communication parameters and/or network traffic parameters.

In some aspects, the adjustment indication transmitted by the network unit indicates the length of a CDRX on-duration. The length of the CDRX on-duration may be indicated in terms of symbols, sub-slots, slots, milliseconds, microseconds, or other suitable unit of measurement. In this regard, the length of the CDRX on-duration may be indicated in terms of an actual length and/or a relative length. For example, in some instances the length of the CDRX on-duration may be indicated relative to a nominal length of the CDRX on-duration.

In some aspects, the adjustment indication transmitted by the network unit indicates the starting time of an SPS occasion as a timing offset associated with the starting time of the SPS occasion. The timing offset may be indicated in terms of symbols, sub-slots, slots, milliseconds, microseconds, or other suitable unit of measurement. In this regard, the timing offset may be relative to a nominal starting time of the SPS occasion, a reception time of the adjustment indication, and/or a transmission time of an acknowledgement (ACK) associated with the adjustment indication.

In some aspects, the adjustment indication transmitted by the network unit indicates the length of an SPS occasion. The length of the SPS occasion may be indicated in terms of symbols, sub-slots, slots, milliseconds, microseconds, or other suitable unit of measurement. In this regard, the length of the SPS occasion may be indicated in terms of an actual length and/or a relative length. For example, in some instances the length of the SPS occasion may be indicated relative to a nominal length of the SPS occasion.

At block 1320, the network unit receives an acknowledgment (ACK) associated with the adjustment indication (e.g., as shown in FIGS. 5-8). The network unit may receive the ACK from a

UE that received the adjustment indication. In this regard, the adjustment indication may have directed specifically to the UE or to a group of UEs that includes the UE. In some instances, the network unit receives the ACK based on when the network unit transmits the adjustment indication and/or the UE receives the adjustment indication (e.g., based on a HARQ process associated with the resources in which the adjustment indication was received). In some instances, the network unit receives the ACK in a time period spaced by a timing offset from a last monitoring occasion of one or more monitoring occasions of the UE (e.g., as shown in FIG. 7). That is, the network unit may receive the ACK using the same resources spaced from the last monitoring occasion regardless of which monitoring occasion the network unit transmits the adjustment indication in. In some instances, the network unit expects to only receive the ACK from the UE and does not expect to receive a negative acknowledgement (NACK) from the UE when the UE fails to receive an adjustment indication during any of the monitoring occasions.

At block 1330, the network unit transmits a communication based on the starting time of the CDRX on-duration, the length of the CDRX on-duration, the starting time of the SPS occasion, and/or the length of the SPS occasion indicated by the adjustment indication. The communication may include one or more PDSCH communications, PDCCH communications, and/or other communications. In some instances, the communication includes a data burst (e.g., XR data bursts 420a, 420b, 440a, 440b of FIG. 4) associated with a data flow (e.g., XR Flow 1 405a and/or XR Flow 2 405b of FIG. 4).

When the adjustment indication includes an indication of the starting time of the CDRX on-duration, the network unit may transmit the communication in a time period based on the starting time of the CDRX on-duration as indicated by the adjustment indication, which may be offset from the nominal starting time of the CDRX on-duration. Similarly, when the adjustment indication includes an indication of the length of the CDRX on-duration, the network unit may transmit the communication in a time period based on the length of the CDRX on-duration as indicated by the adjustment indication, which may be different from the nominal length of the CDRX on-duration. Further, when the adjustment indication includes an indication of both the starting time and the length of the CDRX on-duration, the network unit transmit the communication in a time period based on the starting time and the length of the CDRX on-duration as indicated by the adjustment indication.

When the adjustment indication includes an indication of the starting time of the SPS occasion, the network unit may transmit the communication in a time period based on the starting time of the SPS occasion as indicated by the adjustment indication, which may be offset from the nominal starting time of the SPS occasion. Similarly, when the adjustment indication includes an indication of the length of the SPS occasion, the network unit may transmit the communication in a time period based on the length of the SPS occasion as indicated by the adjustment indication, which may be different from the nominal length of the SPS occasion. Further, when the adjustment indication includes an indication of both the starting time and the length of the SPS occasion, the network unit may transmit the communication in a time period based on the starting time of the SPS occasion as indicated by the adjustment indication and monitor for the communication based on the length of the SPS occasion as indicated by the adjustment indication.

In some aspects, the UE successfully receives and decodes the communication transmitted by the network unit block 1230. In some aspects, the network unit may receive an ACK for the communication. In some instances, the UE fails receive and/or successfully decode the communication transmitted by the network unit block 1230, in which case the network unit may receive a negative acknowledgement (NACK) from the UE or not receive an ACK from the UE.

FIG. 14 is a flow diagram illustrating a wireless communication method 1400 according to one or more aspects of the present disclosure. Aspects of the method 1400 can be executed by a computing device (e.g., a processor, processing circuit, and/or other suitable component) of a wireless communication device or other suitable means for performing the blocks. For instance, the wireless communication device may be a UE (e.g., UE 115 or UE 1000). The UE may utilize one or more components, such as the processor 1002, the memory 1004, the CDRX and/or SPS module 1008, the transceiver 1010, the modem 1012, the RF unit 1014, and/or the one or more antennas 1016, to execute the blocks of method 1200. The method 1400 may employ similar mechanisms as described in FIGS. 4-9. As illustrated, the method 1400 includes a number of enumerated blocks, but aspects of the method 1400 may include additional blocks before, after, and in between the enumerated blocks. In some aspects, one or more of the enumerated blocks may be omitted or performed in a different order.

At block 1410, the UE (e.g., UE 115 or UE 1000) monitors for a wake-up signal (WUS) during one or more monitoring occasions associated with a connected discontinuous reception (CDRX) on-duration (e.g., as shown in FIGS. 5, 7, 8, and 9). In some instances, the UE monitors a physical downlink control channel (PDCCH) for the WUS during the one or more monitoring occasions. The UE may receive from a network unit (e.g., network unit 1100, BS 105, CU 210, DU 230, and/or RU 240) a configuration or other communication indicating a location (e.g., time and/or frequency resources) of the one or more monitoring occasions. The UE may receive the indication of the location of the one or more monitoring occasions via an RRC communication, a PDCCH communication, a PDSCH communication, and/or other suitable communication. In some instances, the one or more monitoring occasions are indicated in a CDRX configuration associated with the CDRX on-duration. The UE may receive from the network unit a configuration or other communication indicating a nominal starting time of the CDRX on-duration and/or the starting time of multiple CDRX on-durations of a CDRX cycle. The UE may receive the indication of the starting time(s) of the CDRX on-duration(s) via an RRC communication, a PDCCH communication, a PDSCH communication, and/or other suitable communication. In some instances, the starting time(s) of the CDRX on-duration(s) are indicated in a CDRX configuration associated with the CDRX on-duration(s).

At block 1420, the UE monitors, based on failing to receive the WUS during the one or more monitoring occasions at block 1410, for a communication associated with a data flow during the CDRX on-duration. The UE may monitor for the communication using a starting time of the CDRX on-duration based on a nominal starting time of the CDRX on-duration and a jitter of the data flow (e.g., maximum jitter, a median jitter, an average jitter, etc.). That is, the UE may determine the starting time for the CDRX on-duration that adjusts the nominal starting time of the CDRX on-duration based on the maximum jitter of the data flow. For example, the UE may determine the starting time of the CDRX on-duration by adding or subtracting time relative to the nominal starting time of the CDRX on-duration based on the maximum jitter. Accordingly, the determined starting time may be the same as the nominal starting time (e.g., when the data flow has no jitter or minimal jitter) or offset from the nominal starting time (e.g., when the data flow has jitter). The UE may monitor for the communication beginning at the determined starting time for the CDRX on-duration.

In some aspects, the UE receives an indication of the jitter of the data flow (e.g., maximum jitter, a median jitter, an average jitter, etc.). The UE may receive the indication of the jitter from the network unit. In some instances, the indication of the jitter may be an explicit indication or an implicit indication. For example, the UE may receive an explicit indication of the jitter (e.g., a maximum jitter measurement, a median jitter measurement, an average jitter measurement, etc.) from the network unit. The network unit may provide the explicit indication of the jitter to the UE to allow the UE to adjust the starting time of one or more CDRX on-duration(s) and/or for other communication purposes. In some aspects, the UE may utilize information regarding jitter received by one or more a higher layer(s) of the UE to determine the jitter parameter utilized to adjust the starting time of the CDRX on-duration. In some instances, the indication of the jitter may be an implicit indication. For example, the UE may receive from the network unit an indication of one or more higher layer parameters associated with the communication flow that may be utilized by the UE to determine the jitter parameter utilized to adjust the starting time of the CDRX on-duration. The UE may receive the explicit and/or implicit indication of jitter via an RRC communication, a PDCCH communication, a PDSCH communication, and/or other suitable communication.

Other aspects of the present disclosure include:

Clause 1. A method of wireless communication performed by a user equipment, the method comprising:
receiving an adjustment indication indicating at least one of a starting time or a length of a connected discontinuous reception (CDRX) on-duration;
transmitting an acknowledgment (ACK) associated with the adjustment indication; and
monitoring, based on the at least one of the starting time or the length of the CDRX on-duration, for a communication.

Clause 2. The method of clause 1, wherein the receiving the adjustment indication comprises at least one of:
receiving, from a network unit, downlink control information (DCI); or
receiving, from a network unit, a media-access control control element (MAC-CE).

Clause 3. The method of any one of clauses 1-2, further comprising:
monitoring a physical downlink control channel (PDCCH) for the adjustment indication during one or more monitoring occasions.

Clause 4. The method of clause 3, further comprising:
receiving, from a network unit, a configuration indicating a location of the one or more monitoring occasions.

Clause 5. The method of clause 3, wherein the transmitting the ACK associated with the adjustment indication comprises:
transmitting the ACK in a time period spaced by a timing offset from a last monitoring occasion of the one or more monitoring occasions.

Clause 6. The method of clause 1, wherein the adjustment indication includes an indication of a timing offset associated with a starting time of the CDRX on-duration.

Clause 7. The method of clause 6, wherein the indication of the timing offset is relative to a nominal starting time of the CDRX on-duration.

Clause 8. The method of clause 6, wherein the indication of the timing offset is relative to a reception time of the adjustment indication.

Clause 9. The method of clause 6, wherein the indication of the timing offset is relative to a transmission time of the ACK.

Clause 10. The method of any one of clauses 1-2, wherein the receiving the adjustment indication comprises:
receiving, from a network unit, a physical downlink shared channel (PDSCH) communication.

Clause 11. The method of clause 10, wherein the PDSCH communication is associated with an SPS occasion associated with a CDRX cycle.

Clause 12. The method of clause 11, wherein the PDSCH communication includes a media access control control element (MAC-CE) carrying the adjustment indication of the starting time of the CDRX on-duration for the CDRX cycle.

Clause 13. The method of clause 11, wherein the PDSCH communication includes a media access control control element (MAC-CE) indicating at least one of a timing offset for the CDRX on-duration or the length of the CDRX on-duration.

Clause 14. The method of any one of clauses 1-13, wherein:
the adjustment indication includes the indication of the starting time of the CDRX on-duration; and
the monitoring is based on the starting time of the CDRX on-duration.

Clause 15. The method of any one of clauses 1-13, wherein:
the adjustment indication includes the indication of the length of the CDRX on-duration; and
the monitoring is based on the length of the CDRX on-duration.

Clause 16. The method of any one of clauses 1-13, further comprising:
receiving, based on the monitoring, the communication.

Clause 17. A method of wireless communication performed by a network unit, the method comprising:
transmitting an adjustment indication indicating at least one of a starting time or a length of a connected discontinuous reception (CDRX) on-duration;
receiving an acknowledgment (ACK) associated with the adjustment indication; and
transmitting, based on the at least one of the starting time or the length of the CDRX on-duration, a communication.

Clause 18. The method of clause 17, wherein the transmitting the adjustment indication comprises at least one of:
transmitting, to a user equipment, downlink control information (DCI); or
transmitting, to a user equipment, a media-access control control element (MAC-CE).

Clause 19. The method of any one of clauses 17-18, further comprising:
transmitting, to a user equipment, a configuration indicating a location of one or more physical downlink control channel (PDCCH) monitoring occasions.

Clause 20. The method of clause 19, wherein the transmitting the adjustment indication comprises:
transmitting downlink control information (DCI) during the one or more PDCCH monitoring occasions.

Clause 21. The method of any one of clauses 19-20, wherein the receiving the ACK associated with the adjustment indication comprises:
receiving the ACK in a time period spaced by a timing offset from a last PDCCH monitoring occasion of the one or more PDCCH monitoring occasions.

Clause 22. The method of clause 17, wherein the adjustment indication includes an indication of a timing offset associated with a starting time of the CDRX on-duration.

Clause 23. The method of clause 22, wherein the indication of the timing offset is relative to a nominal starting time of the CDRX on-duration.

Clause 24. The method of clause 22, wherein the indication of the timing offset is relative to a reception time of the adjustment indication.

Clause 25. The method of clause 22, wherein the indication of the timing offset is relative to a transmission time of the ACK.

Clause 26. The method of any one of clauses 17-18, wherein the transmitting the adjustment indication comprises:
transmitting, to a user equipment, a physical downlink shared channel (PDSCH) communication.

Clause 27. The method of clause 26, wherein the PDSCH communication is associated with an SPS occasion associated with a CDRX cycle.

Clause 28. The method of clause 27, wherein the PDSCH communication includes a medium access control control element (MAC-CE) carrying the indication of the starting time of the CDRX on-duration for the CDRX cycle.

Clause 29. The method of clause 28, wherein the MAC-CE indicates at least one of a timing offset for the CDRX on-duration or the length of the CDRX on-duration.

Clause 30. The method of any one of clauses 17-29, wherein:
the adjustment indication includes the indication of the starting time of the CDRX on-duration; and
the transmitting is based on the starting time of the CDRX on-duration.

Clause 31. The method of any one of clauses 17-29, wherein:
the adjustment indication includes the indication of the length of the CDRX on-duration; and
the transmitting is based on the length of the CDRX on-duration.

Clause 32. A method of wireless communication performed by a user equipment, the method comprising:
monitoring for a wake-up signal (WUS) during one or more monitoring occasions associated with a connected discontinuous reception (CDRX) on-duration; and
monitoring, based on failing to receive the WUS during the one or more monitoring occasions, for a communication associated with a data flow during the CDRX on-duration, wherein a starting time of the CDRX on-duration is based on a nominal starting time of the CDRX on-duration and a maximum jitter of the data flow.

Clause 33. The method of clause 32, further comprising:
determining the starting time for the CDRX on-duration based on the nominal starting time of the CDRX on-duration and the maximum jitter of the data flow, wherein the determined starting time is different than the nominal starting time.

Clause 34. The method of clause 33, wherein the monitoring for the communication comprises:
monitoring for the communication beginning at the determined starting time for the CDRX on-duration.

Clause 35. The method of any one of clauses 32-34, further comprising:
receiving, from a network unit, an indication of the maximum jitter.

Clause 36. A method of wireless communication performed by a user equipment, the method comprising:
receiving an adjustment indication indicating at least one of a starting time or a length of a semi-persistent scheduling (SPS) occasion;
transmitting an acknowledgment (ACK) associated with the adjustment indication; and
monitoring, based on the at least one of the starting time or the length of the SPS occasion, for a communication.

Clause 37. The method of clause 36, wherein the receiving the adjustment indication comprises at least one of:
receiving, from a network unit, downlink control information (DCI), or
receiving, from a network unit, a media-access control control element (MAC-CE).

Clause 38. The method of any one of clauses 36-37, further comprising:
monitoring a physical downlink control channel (PDCCH) for the adjustment indication during one or more monitoring occasions.

Clause 39. The method of clause 38, further comprising:
receiving, from a network unit, a configuration indicating a location of the one or more monitoring occasions.

Clause 40. The method of clause 38, wherein the transmitting the ACK associated with the adjustment indication comprises:
transmitting the ACK in a time period spaced by a timing offset from a last monitoring occasion of the one or more monitoring occasions.

Clause 41. The method of clause 40, wherein the adjustment indication includes an indication of a timing offset associated with a starting time of the SPS occasion.

Clause 42. The method of clause 41, wherein the indication of the timing offset is relative to a nominal starting time of the SPS occasion.

Clause 43. The method of clause 41, wherein the indication of the timing offset is relative to a reception time of the adjustment indication.

Clause 44. The method of clause 41, wherein the indication of the timing offset is relative to a transmission time of the ACK.

Clause 45. The method of any one of clauses 36-37, wherein the receiving the adjustment indication comprises:
receiving, from a network unit, a physical downlink shared channel (PDSCH) communication.

Clause 46. The method of clause 45, wherein the PDSCH communication includes a media access control control element (MAC-CE) carrying the adjustment indication of the starting time of the SPS occasion.

Clause 47. The method of clause 45, wherein the PDSCH communication includes a media access control control element (MAC-CE) indicating at least one of a timing offset for the SPS occasion or the length of the SPS occasion.

Clause 48. The method of any one of clauses 36-47, wherein:
the adjustment indication includes the indication of the starting time of the SPS occasion; and
the monitoring is based on the starting time of the SPS occasion.

Clause 49. The method of any one of clauses 36-47, wherein:
the adjustment indication includes the indication of the length of the SPS occasion; and
the monitoring is based on the length of the SPS occasion.

Clause 50. The method of any one of clauses 36-49, further comprising:
receiving, based on the monitoring, the communication.

Clause 51. A method of wireless communication performed by a network unit, the method comprising:
transmitting an adjustment indication indicating at least one of a starting time or a length of a semi-persistent scheduling (SPS) occasion;
receiving an acknowledgment (ACK) associated with the adjustment indication; and
transmitting, based on the at least one of the starting time or the length of the SPS occasion, a communication.

Clause 52. The method of clause 51, wherein the transmitting the adjustment indication comprises at least one of:
transmitting, to a user equipment, downlink control information (DCI); or
transmitting, to a user equipment, a media-access control control element (MAC-CE).

Clause 53. The method of clause any one of clauses 51-52, further comprising:
transmitting, to a user equipment, a configuration indicating a location of one or more physical downlink control channel (PDCCH) monitoring occasions.

Clause 54. The method of clause 53, wherein the transmitting the adjustment indication comprises:
transmitting downlink control information (DCI) during the one or more PDCCH monitoring occasions.

Clause 55. The method of any one of clauses 53-54, wherein the receiving the ACK associated with the adjustment indication comprises:
receiving the ACK in a time period spaced by a timing offset from a last PDCCH monitoring occasion of the one or more PDCCH monitoring occasions.

Clause 56. The method of clause 51, wherein the adjustment indication includes an indication of a timing offset associated with a starting time of the SPS occasion.

Clause 57. The method of clause 56, wherein the indication of the timing offset is relative to a nominal starting time of the SPS occasion.

Clause 58. The method of clause 56, wherein the indication of the timing offset is relative to a reception time of the adjustment indication.

Clause 59. The method of clause 56, wherein the indication of the timing offset is relative to a transmission time of the ACK.

Clause 60. The method of clause 51-52, wherein the transmitting the adjustment indication comprises:
transmitting, to a user equipment, a physical downlink shared channel (PDSCH) communication.

Clause 61. The method of clause 27, wherein the PDSCH communication includes a medium access control control element (MAC-CE) carrying the indication of the starting time of the SPS occasion.

Clause 62. The method of clause 28, wherein the MAC-CE indicates at least one of a timing offset for the SPS occasion or the length of the SPS occasion.

Clause 63. The method of any one of clauses 51-62, wherein:
the adjustment indication includes the indication of the starting time of the SPS occasion; and
the transmitting is based on the starting time of the SPS occasion.

Clause 64. The method of any one of clauses 51-62, wherein:
the adjustment indication includes the indication of the length of the SPS occasion; and
the transmitting is based on the length of the SPS occasion.

Clause 65. A non-transitory computer-readable medium storing one or more instructions for wireless communication, the one or more instructions comprising one or more instructions that, when executed by one or more processors of a UE, cause the UE to perform any one of aspects of clauses 1-16.

Clause 66. A non-transitory computer-readable medium storing one or more instructions for wireless communication, the one or more instructions comprising one or more instructions that, when executed by one or more processors of a UE, cause the UE to perform any one of aspects of clauses 17-31.

Clause 67. A non-transitory computer-readable medium storing one or more instructions for wireless communication, the one or more instructions comprising one or more instructions that, when executed by one or more processors of a UE, cause the UE to perform any one of aspects of clauses 32-50.

Clause 68. A non-transitory computer-readable medium storing one or more instructions for wireless communication, the one or more instructions comprising one or more instructions that, when executed by one or more processors of a UE, cause the UE to perform any one of aspects of clauses 51-64.

Clause 69. A user equipment (UE) comprising one or more means to perform any one or more aspects of clauses 1-16.

Clause 70. A user equipment (UE) comprising one or more means to perform any one or more aspects of clauses 17-31.

Clause 71. A user equipment (UE) comprising one or more means to perform any one or more aspects of clauses 32-50.

Clause 72. A user equipment (UE) comprising one or more means to perform any one or more aspects of clauses 51-64.

Clause 73. A user equipment (UE) comprising: a memory; a transceiver; and at least one processor coupled to the memory and the transceiver, wherein the UE is configured to perform any one or more aspects of clauses 1-16.

Clause 74. A user equipment (UE) comprising: a memory; a transceiver; and at least one processor coupled to the memory and the transceiver, wherein the UE is configured to perform any one or more aspects of clauses 17-31.

Clause 75. A user equipment (UE) comprising: a memory; a transceiver; and at least one processor coupled to the memory and the transceiver, wherein the UE is configured to perform any one or more aspects of clauses 32-50.

Clause 76. A user equipment (UE) comprising: a memory; a transceiver; and at least one processor coupled to the memory and the transceiver, wherein the UE is configured to perform any one or more aspects of clauses 51-64.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

1. A method of wireless communication performed by a user equipment, the method comprising:
receiving an adjustment indication indicating at least one of a starting time or a length of a connected discontinuous reception (CDRX) on-duration;
transmitting an acknowledgment (ACK) associated with the adjustment indication; and
monitoring, based on the at least one of the starting time or the length of the CDRX on-duration, for a communication.

2. The method of claim 1, wherein the receiving the adjustment indication comprises at least one of:
receiving, from a network unit, downlink control information (DCI); or
receiving, from a network unit, a media-access control control element (MAC-CE).

3. The method of claim 1, further comprising:
monitoring a physical downlink control channel (PDCCH) for the adjustment indication during one or more monitoring occasions.

4. The method of claim 3, further comprising:
receiving, from a network unit, a configuration indicating a location of the one or more monitoring occasions.

5. The method of claim 3, wherein the transmitting the ACK associated with the adjustment indication comprises:
transmitting the ACK in a time period spaced by a timing offset from a last monitoring occasion of the one or more monitoring occasions.

6. The method of claim 1, wherein the adjustment indication includes an indication of a timing offset associated with a starting time of the CDRX on-duration.

7. The method of claim 6, wherein the indication of the timing offset is relative to at least one of:
a nominal starting time of the CDRX on-duration;
a reception time of the adjustment indication; or
a transmission time of the ACK.

8. The method of claim 1, wherein the receiving the adjustment indication comprises:
receiving, from a network unit, a physical downlink shared channel (PDSCH) communication.

9. The method of claim 8, wherein the PDSCH communication is associated with an SPS occasion associated with a CDRX cycle, the PDSCH communication including a media access control control element (MAC-CE) carrying the adjustment indication of the starting time of the CDRX on-duration for the CDRX cycle.

10. The method of claim 8, wherein the PDSCH communication includes a media access control control element (MAC-CE) indicating at least one of a timing offset for the CDRX on-duration or the length of the CDRX on-duration.

11. The method of claim 1, wherein:
the adjustment indication includes an indication of the starting time of the CDRX on-duration; and
the monitoring is based on the starting time of the CDRX on-duration.

12. The method of claim 1, wherein:
the adjustment indication includes an indication of the length of the CDRX on-duration; and
the monitoring is based on the length of the CDRX on-duration.

13. The method of claim 1, further comprising:
receiving, based on the monitoring, the communication.

14. A user equipment (UE), comprising:
a memory;
a transceiver; and
at least one processor coupled to the memory and the transceiver, wherein the UE is configured to:
receive an adjustment indication indicating at least one of a starting time or a length of a connected discontinuous reception (CDRX) on-duration;
transmit an acknowledgment (ACK) associated with the adjustment indication; and
monitor, based on the at least one of the starting time or the length of the CDRX on-duration, for a communication.

15. The UE of claim 14, wherein the UE is configured to receive the adjustment indication via at least one of:
downlink control information (DCI) from a network unit; or
a media-access control control element (MAC-CE) from a network unit.

16. The UE of claim 14, wherein the UE is further configured to:
receive, from a network unit, a configuration indicating a location of one or more monitoring occasions;
monitor a physical downlink control channel (PDCCH) for the adjustment indication during the one or more monitoring occasions.

17. The UE of claim 16, wherein the UE is configured to transmit the ACK associated with the adjustment indication in a time period spaced by a timing offset from a last monitoring occasion of the one or more monitoring occasions.

18. The UE of claim 17, wherein the UE is further configured to:
receive, from the network unit, the adjustment indication including an indication of a timing offset associated with a starting time of the CDRX on-duration; and
wherein the indication of the timing offset is relative to at least one of:
a nominal starting time of the CDRX on-duration;
a reception time of the adjustment indication; or
a transmission time of the ACK.

19. The UE of claim 14, wherein the UE is configured to receive the adjustment indication via a physical downlink shared channel (PDSCH) communication from a network unit, the PDSCH communication including a media access control control element (MAC-CE) indicating at least one of a timing offset for the CDRX on-duration or the length of the CDRX on-duration.

20. The UE of claim 19, wherein the PDSCH communication is associated with an SPS occasion associated with a CDRX cycle.

21. The UE of claim 1, wherein:
the adjustment indication includes an indication of the starting time of the CDRX on-duration; and
the UE is configured to monitor for the communication based on the starting time of the CDRX on-duration.

22. The method of claim 1, wherein:
the adjustment indication includes an indication of the length of the CDRX on-duration; and
the UE is configured to monitor for the communication based on the length of the CDRX on-duration.

23. The UE of claim 14, wherein the UE is further configured to:
receive, based on the monitoring, the communication.

24. A method of wireless communication performed by a user equipment, the method comprising:
monitoring for a wake-up signal (WUS) during one or more monitoring occasions associated with a connected discontinuous reception (CDRX) on-duration; and
monitoring, based on failing to receive the WUS during the one or more monitoring occasions, for a communication associated with a data flow during the CDRX on-duration, wherein a starting time of the CDRX on-duration is based on a nominal starting time of the CDRX on-duration and a maximum jitter of the data flow.

25. The method of claim 24, further comprising:
determining the starting time for the CDRX on-duration based on the nominal starting time of the CDRX on-duration and the maximum jitter of the data flow, wherein the determined starting time is different than the nominal starting time.

26. The method of claim 25, wherein the monitoring for the communication comprises:
monitoring for the communication beginning at the determined starting time for the CDRX on-duration.

27. The method of claim 24, further comprising:
receiving, from a network unit, an indication of the maximum jitter.

28. A user equipment (UE), comprising:
a memory;
a transceiver; and
at least one processor coupled to the memory and the transceiver, wherein the UE is configured to:
monitor for a wake-up signal (WUS) during one or more monitoring occasions associated with a connected discontinuous reception (CDRX) on-duration; and
monitor, based on failing to receive the WUS during the one or more monitoring occasions, for a communication associated with a data flow during the CDRX on-duration, wherein a starting time of the CDRX on-duration is based on a nominal starting time of the CDRX on-duration and a maximum jitter of the data flow.

29. The UE of claim 28, wherein the UE is further configured to:
determine the starting time for the CDRX on-duration based on the nominal starting time of the CDRX on-duration and the maximum jitter of the data flow, wherein the determined starting time is different than the nominal starting time; and
monitor for the communication beginning at the determined starting time for the CDRX on-duration.

30. The UE of claim 28, wherein the UE is further configured to:
receive, from a network unit, an indication of the maximum jitter.
